(19) United States
(12) Patent Application Publication
(10) Pub. No.: US 2001/0012814 A1
(43) Pub. Date: Aug. 9, 2001

(54) Motor driven centrifugal filter

(76) Inventors: David F. May, Columbus, IN (US); Louis A. Krempel, Columbus, IN (US)

Correspondence Address: Todd T. Taylor, TAYLOR & AUST, P.C., 142 S. Main St., P.O. Box 560, Avilla, IN, 46710, US

(21) Appl. No.: 09/817,698

(22) Filed: Mar. 26, 2001

Related U.S. Application Data
(63) Continuation-in-part of application No. 09/352,294, filed on Jul. 12, 1999, now Pat. No. 6,213,929.
(60) Provisional application No. 60/192,656, filed on Mar. 28, 2000.
(60) Provisional application No. 60/232,007, filed on Sep. 12, 2000.

(51) Int. Cl. B04B 9/06

(52) U.S. Cl. 494/24; 494/36; 494/49; 494/84

(57) ABSTRACT

A centrifugal filter assembly for filtering particulates from a fluid medium includes a non-rotating filter housing. A filter is disposed within the housing. The filter is rotatable relative to the housing about an axis of rotation. The filter has an inlet and an outlet for the fluid medium. A filter medium is disposed within the filter. A drive mechanism rotates the filter.

### CROSS REFERENCE TO RELATED APPLICATIONS

This is a non-provisional patent application based upon U.S. Provisional Patent Application Ser. No. 60/192,656, entitled “ELECTRIC MOTOR DRIVEN CENTRIFUGAL FILTER WITH MEDIA TO IMPROVE FILTRATION EFFICIENCY”, filed Mar. 28, 2000, and U.S. Provisional Patent Application Ser. No. 60/232,007, entitled “MOTOR CONTROLLER FOR CENTRIFUGAL FILTER”, filed Sep. 11, 2000; and is also a continuation-in-part of U.S. patent application Ser. No. 09/352,294, entitled “MOTOR DRIVEN CENTRIFUGAL FILTER”, filed Jul. 12, 1999.

### BACKGROUND OF THE INVENTION

1. Field of the Invention

The present invention relates to centrifugal filters for filtering particulates from a liquid using centrifugal force.

2. Description of the Related Art

Many types of fluids contain particulates which need to be filtered out for subsequent use of the fluid. Examples of such fluids include medical and biological fluids, machining and cutting fluids, and lubricating oils. With particular reference to an internal combustion engine, a lubricating oil such as engine oil may contain particulates which are filtered out to prevent mechanical or corrosive wear of the engine.

Diesel engine mechanical wear, especially that relating to boundary lubricated wear, is a direct function of the amount of particulates in the lubricating oil. A particulate which is extremely detrimental to engine wear is soot, formed during the combustion process, and deposited into the crankcase through combustion gas blow-by and piston rings scraping of the cylinder walls. Soot is a carbonaceous polycyclic hydrocarbon which has extremely high surface area whereby it interacts chemically with adsorptive association with other lubricant species. Particle sizes of most diesel engine lubricant soot is between 100 Angstroms and 3 microns. Ranges of concentration are between 0 and 10 percent by weight depending on many factors. Because engine wear will dramatically increase with the soot level in the lubricating oil, engine manufacturers specify a certain engine drain oil interval to protect the engine from this type of mechanical wear. Current sieve type filters do not remove sufficient amounts of soot to provide soot related wear protection to the engine.

Centrifugal filters for lubricant filtration are generally known. Current production centrifugal lubricant oil filters are powered by hero turbines, which are part of the oil filter canister, or through direct mechanical propulsion. Hero turbine powered filters are limited by the supplied oil pressure from the engine, and only can operate up to maximum speeds around 4000 revolutions per minute (RPM) with oil pressures nominally at less than 40 psi. In addition, hero turbine powered filters pass oil through the filter canister as it migrates toward the attached hero turbine jets. Therefore, the lubricant mean residence time is less than a few minutes. None of the currently available centrifugal filters which operate on the basis of a hero turbine provide satisfactory soot removal rates. Soot removal from engine lubricating oil requires greater G forces and longer residence times than is demonstrated with currently commercially available hero turbine powered filters.

It is also known to drive a centrifugal filter using a mechanical linkage from a turbine. The turbine receives a flow of engine exhaust air and drives a mechanical output shaft which in turn is coupled with a filter inside a centrifugal filter assembly. The rotational speed of the filter is sufficient to separate particulates within the engine oil. An example of such a filter is disclosed in U.S. Pat. No. 5,779,618 (Onodera, et al.).

All of the units described above and others commercially available fall generally in groups of hero turbine design or direct mechanical actuation. While direct mechanically driven systems are capable of reaching the necessary G forces to provide soot removal, this type of linkage is generally very expensive and requires extensive modification of engines to adapt. While hero turbines do not suffer from this problem, insufficient G forces limit these filters from removing soot.

### SUMMARY OF THE INVENTION

The present invention provides a centrifugal filter assembly which is driven by a brushless direct current motor and includes a venturi section.

The present invention also provides an electric motor to drive a cone-stack centrifugal filter. A cone-stack may be used to increase the particulate matter separation efficiency within the centrifugal filter. Several other devices for improving particulate matter separation efficiency were disclosed in the U.S. patent applications cited in the section, “Cross Reference to Related Applications.” The electric motor provides the driving mechanism by which the filter will rotate at high speeds, generally between 4,000 and 25,000 revolutions per minute (RPM). The electric motor can be powered by the electric current available on commercially available trucks and diesel-powered vehicles.

Another embodiment of this invention is for filtering particulates from lubricant oil on a diesel engine. A centrifugal filter assembly is connected to the diesel engine lubricant supply. The motor is connected to the vehicle electrical supply power. The filter element is rotated at speeds between 4,000 and 25,000 RPM, creating sufficient centrifugal forces to separate soot from lubricant oil. The soot and other particulate matter are trapped within the cone-stack element, and clean oil returns to the engine sump.

The cone-stack media is utilized to improve filtration efficiency. This media may also be employed in centrifugal systems which are driven by means other than a turbine or electric motor. Examples include drive sources such as a belt, gear, exhaust gas turbine, pressurized air, and other devices by which the filter element may be rotated.

The invention comprises, in one form thereof, a centrifugal filter assembly for filtering particulates from a fluid medium. A filter is disposed within a non-rotating filter housing. The filter is rotatable relative to the housing about an axis of rotation. The filter has an inlet and an outlet for the fluid medium. A filter medium is disposed within the filter. A drive mechanism rotates the filter.

An advantage of the present invention is that the rotating filter is driven by the brushless DC motor at a speed which is sufficient to filter soot from the engine oil.

Another advantage is that the filter head includes a venturi section which generates a vacuum within the housing to remove filtered oil from the housing.

Yet another advantage is that the motor may be carried by a printed circuit board within the filter head, thereby reducing the size of the filter assembly.

Still another advantage is that the filter may be detachably engaged by the motor in the filter head, thereby allowing the filter to be used as a spin-on filter.

A still further advantage is that the housing includes two annular seals with an annular groove therebetween which is in communication with a drain tube, thereby further enabling use as a spin-on filter.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective, sectional view of an embodiment of a centrifugal filter assembly of the present invention;

FIG. 2 is a side, sectional view of another embodiment of a centrifugal filter assembly of the present invention;

FIG. 3 is a sectional view taken along line 3-3 in FIG. 2;

FIG. 4 is a fragmentary, side view of still another embodiment of a centrifugal filter assembly of the present invention;

FIG. 5 is a fragmentary, side view of another embodiment of a centrifugal filter assembly of the present invention;

FIG. 6 is a perspective view of an embodiment of a filter of the present invention;

FIG. 7 is a simplified, side view of still another embodiment of a centrifugal filter assembly of the present invention;

FIG. 8 is a perspective view of an embodiment of a turbine for use with the centrifugal filter assembly of the present invention;

FIG. 9 is a perspective view of another embodiment of a turbine for use with the centrifugal filter assembly of the present invention;

FIG. 10 is a perspective view of yet another embodiment of a turbine for use with the centrifugal filter assembly of the present invention;

FIG. 11 is a perspective view of still another embodiment of a turbine for use with the centrifugal filter assembly of the present invention;

FIG. 12 is a perspective view of a further embodiment of a variable geometry turbine for use with the centrifugal filter assembly of the present invention;

FIG. 13 is a perspective view of yet another embodiment of a turbine for use with the centrifugal filter assembly of the present invention;

FIG. 14 is a side sectional view of another embodiment of a centrifugal filter assembly of the present invention;

FIG. 15 is an exploded, perspective view of the filter head of FIG. 14;

FIG. 16 is an exploded, partially sectioned view of the centrifugal filter assembly of FIGS. 14 and 15;

FIG. 17 is a side, sectional view of another embodiment of a centrifugal filter assembly of the present invention;

FIG. 18 is a side, sectional view of another embodiment of a centrifugal filter assembly of the present invention;

FIG. 19 is a side, sectional view of another embodiment of a centrifugal filter assembly of the present invention;

FIG. 20 is a side, sectional view of another embodiment of a centrifugal filter assembly of the present invention;

FIG. 21 is a side view of another embodiment of a filter head used with a centrifugal filter assembly of the present invention;

FIG. 22 is a side view of a portion of a filter head used in another embodiment of a centrifugal filter assembly of the present invention;

FIG. 23 is a perspective, partially fragmentary view of another embodiment of a centrifugal filter assembly of the present invention;

FIG. 24 is a perspective, partially fragmentary view of another embodiment of a centrifugal filter assembly of the present invention;

FIGS. 25 and 26 illustrate an embodiment of a gear box which may be used with an internal combustion engine to provide power to a centrifugal filter assembly of the present invention;

FIG. 27 is a perspective, partially fragmentary view of another embodiment of a centrifugal filter assembly of the present invention;

FIG. 28 is a side, sectional view of another embodiment of a centrifugal filter assembly of the present invention;

FIG. 29 is a side, sectional view of a centrifugal filter assembly with a brushless direct current electric motor.

FIG. 30 is a cross-sectional view of one embodiment of a check ball valve of the present invention;

FIG. 31 is a cross-sectional view of one embodiment of an oil flow valve of the present invention;

FIG. 32 is a cross-sectional view of one embodiment of a vent valve of the present invention;

FIG. 33 is a cross-sectional view of one embodiment of an oil flow restrictor of the present invention;

FIG. 34 is a fragmentary, enlarged, side, sectional view of the centrifugal filter assembly of FIG. 19;

FIG. 35 is a diagram of the flow of engine oil through the valves and oil flow restrictor of FIGS. 30-33;

FIG. 36 is a cross-sectional view of one embodiment of a truck with a diesel engine on which a filter assembly of the present invention is mounted; and

FIG. 37 is a cross-sectional view of another embodiment of a turbine driven centrifugal filter assembly of the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

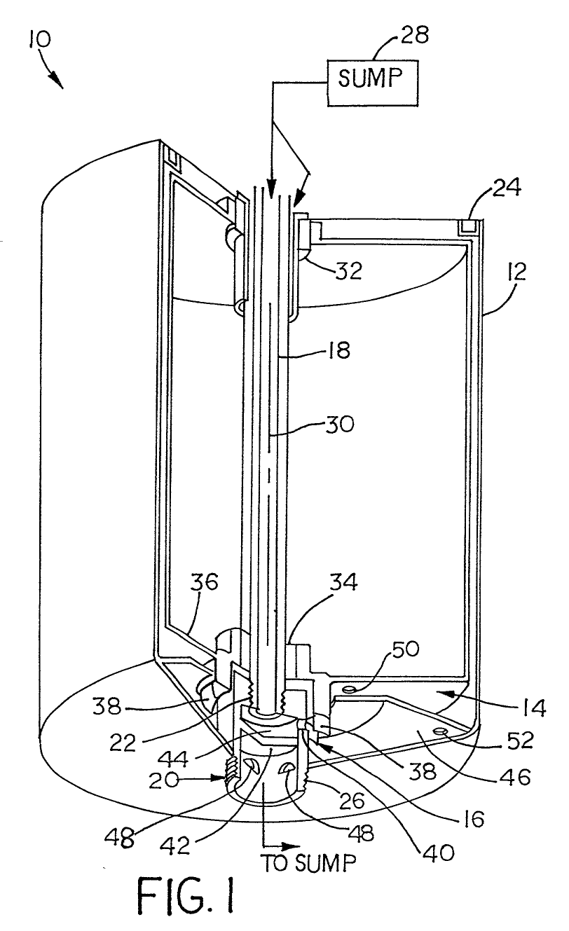

Referring now to the drawings, and more particularly to FIG. 1, there is shown an embodiment of a centrifugal filter assembly 10 of the present invention for filtering particulates from a fluid. For example, centrifugal filter assembly 10 may be used to filter soot from engine oil in a diesel engine, and will be described accordingly. Centrifugal filter assembly 10 may be used for other applications, such as medical applications for separating particulates from a bodily or medical fluid, or machining and cutting applications for separating metallic particles from a hydraulic fluid or lubricating oil.

Centrifugal filter assembly 10 generally includes a housing 12, rotating filter 14 and turbine 16. Housing 12 contains filter 14 and defines a generally fluid-tight vessel. For example, housing 12 may be used as part of a bypass filter assembly for use with an internal combustion engine. When configured as such, a central supply tube 18 disposed in communication with a sump 28 extends outwardly from the engine. Housing 12 includes a hub 20 which is rigidly attached therewith. Hub 20 includes an internal threaded portion 22 which threadingly engages external threads on supply tube 18. Screwing hub 20 onto supply tube 18 causes housing 12 to axially seal against the engine. An annular seal 24 on an axial end face of housing 12 effects a fluid tight seal with the engine. Hub 20 includes external threads 26 allowing attachment with suitable fluid conduits (not shown) for recirculating oil transported through filter assembly 10 back to sump 28.

Filter 14 is disposed within and rotatable relative to housing 12 about an axis of rotation 30 defined by supply tube 18. Filter 14 may be rotatably carried using a pair of reduced friction bearings 32 and 34 disposed at each axial end thereof. Bearings 32 and 34 may be, e.g., roller bearings, ball bearings or another type of reduced friction bearing supports such as a bushing. Filter 14 may include a suitable medium therein (not shown) allowing filtration of the fluid which is transported through filter 14. For example, the medium disposed within filter 14 may be in the form of a spiral wrapped and embossed sheet of metal or plastic material, as will be described in greater detail hereinafter.

Turbine 16 is connected to filter 14 at an axial end thereof. In the embodiment shown, turbine 16 is attached to a bottom wall 36 of filter 14 via welding, a suitable adhesive or the like. The interconnection between turbine 16 and filter 14 causes rotation of turbine 16 to in turn rotate filter 14 about axis of rotation 30.

Turbine 16 includes a plurality of blades 38 which extend generally radially relative to axis of rotation 30. Blades 38 may extend substantially through axis of rotation 30, or may be positioned at an angle offset from axis of rotation 30. Moreover, blades 38 may be configured with a particular shape which is curved, straight, segmented, a combination of the same, etc., to provide a desired rotational speed of filter 14 during operation.

Hub 20 of housing 12 includes at least one fluid port 40 defining a nozzle through which a pressurized fluid is jetted to impact upon turbine blades 38. In the embodiment shown, hub 20 includes a single fluid port 40 defining a nozzle, although a greater number of fluid ports may also be provided. A wall 42 disposed within hub 20 defines a pressure chamber 44 in communication with each of an internal bore of supply tube 18 and fluid port 40. The pressurized fluid is transported through supply tube 18 into pressure chamber 44 and is jetted from fluid port 40. The pressurized fluid which is jetted from fluid port 40 sequentially impinges upon blades 38 of turbine 16. The pressurized fluid is jetted from fluid port 40 in a direction which is substantially perpendicular to axis of rotation 30, thereby eliminating force vectors in a direction parallel to axis of rotation 30 and maximizing the force imparted on each blade 38. The curvature and/or positioning of each blade 38 causes a rotational moment to be exerted on turbine 16, which in turn causes turbine 16 and filter 14 to rotate about axis of rotation 30.

A splash shield 46 is attached to housing 12 and is disposed radially around turbine 16 above blades 38. Pressurized fluid which is jetted radially outwardly from fluid port 40 against turbine blades 38 falls to a bottom of housing 12 and exits through drain holes 48 in hub 20. Splash shield 46 prevents an appreciable amount of pressurized fluid from spraying against a side wall of housing 12 and impacting against filter 14. Impact of the pressurized fluid would provide aerodynamic drag on filter 14 and slow the rotational speed thereof. A relatively small radial clearance is provided between turbine 16 and splash shield 46 to minimize the amount of pressurized fluid which flows past splash shield 46 to an area adjacent filter 14.

Filter 14 fills with oil to be filtered during operation. One or more exit holes 50 are provided in the bottom side of filter 14. The size and number of holes 50, as well as the fluid input rate into filter 14 is a function of the desired throughput rate through filter 14 and residence time of the fluid within filter 14. Engine oil which drains through holes 50 in the bottom of filter 14 flows down the top of splash shield 46, through one or more holes 52 in splash shield 46, and out through drain holes 48 in hub 20.

During use, a pressurized fluid is transported from sump 28 to supply tube 18. When used with an internal combustion engine, the pressurized fluid may be in the form of engine oil which is pressurized using an oil pump to a pressure of between 30 and 70 pounds per square inch (psi), and more particularly approximately 45 psi. Approximately 90 percent (which actual percentage may vary) of the circulated engine oil is transported through supply tube 18 to pressure chamber 44 for discharging in a generally radially outward direction relative to axis of rotation 30 against turbine blades 38 of turbine 16. The pressurized engine oil causes turbine 16 to rotate at a speed of between approximately 5,000 and 20,000 revolutions per minute (RPM), more preferably between approximately 10,000 and 20,000 RPM. The remaining 10 percent of the engine oil is transported into filter 14 for centrifugal filtration. The high rotational speed of filter 14 creates a G force which is high enough to cause centrifugal separation of particulates carried within the engine oil. The particulates migrate radially outwardly within filter 14 and are contained within filter 14. Periodic changing of filter 14 allows the trapped particulates within filter 14 to be merely discarded along with filter 14.

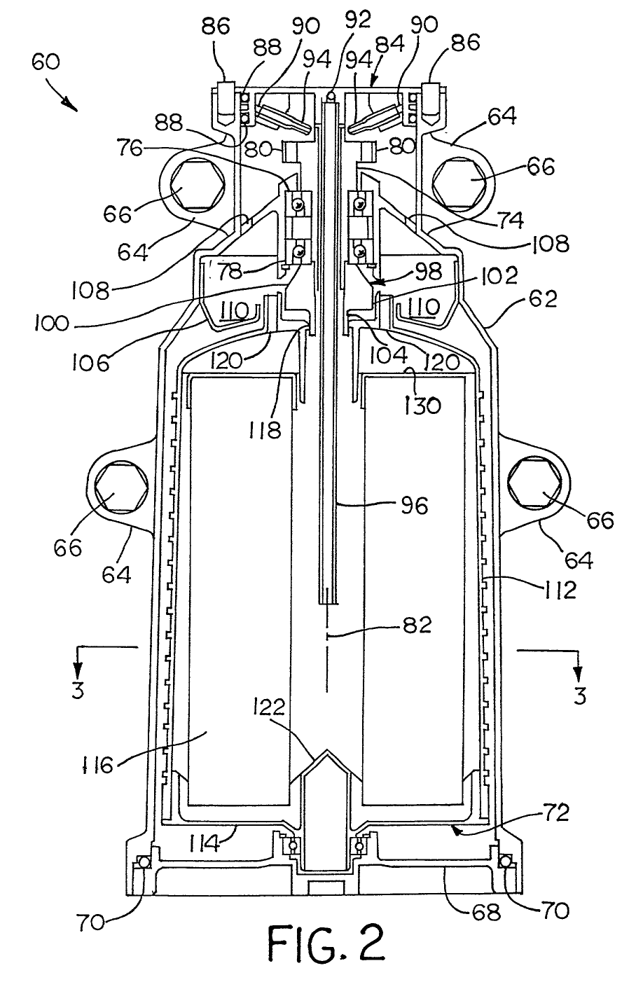

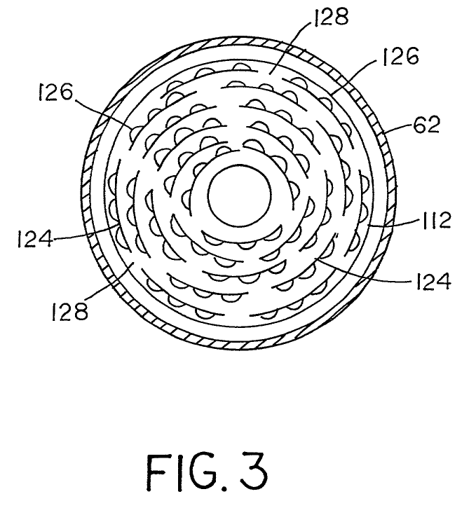

Referring now to FIGS. 2 and 3, there is shown another embodiment of a centrifugal filter assembly 60 of the present invention. For purposes of illustration, centrifugal filter assembly 60 will be described for use with an internal combustion engine, but it is to be understood that filter assembly 60 may be utilized for other applications.

Housing 62 is attached to an engine (not shown) utilizing flanges 64 and bolts 66. A bottom cover 68 is threadingly engaged with housing 62 and is sealed with housing 62 using an annular O-ring 70. Bottom cover 68 may be removed from housing 62 to allow replacement of filter 72, as will be described in greater detail hereinafter.

Turbine 74 is rotatably carried by housing 62 using one or more reduced friction bearings, such as ball bearing assemblies 76 and 78. Turbine 74 includes a plurality of blades 80 disposed around the periphery thereof. Blades 80 extend generally radially relative to an axis of rotation 82, and have a selected shape to provide a desired rotational speed of turbine 74. The shape of blades 80 and the distance from axis of rotation 82 both have an effect on the rotational speed and are determined for a particular application (e.g., empirically).

A top cover 84 is fastened to housing 62 using, e.g., bolts 86. Seals such as O-rings 88 provide a fluid tight seal between top cover 84 and housing 62. Top cover 84 includes suitable porting 90 and 92 to be fluidly connected with a source of pressurized fluid and the fluid to be filtered, respectively. In the embodiment shown, porting 90 and 92 are each connected with a source of pressurized engine oil which provides both the source of pressurized fluid for rotating turbine 74 and the fluid to be filtered.

Nozzles 94 are attached to and carried by top cover 84, and direct a source of pressurized fluid at selected locations against blades 80 of turbine 74. As viewed in FIG. 2, the left hand nozzle 94 is disposed behind central supply tube 96 and the right hand nozzle 94 is disposed in front of supply tube 96. Nozzles 94 thus both jet a pressurized fluid which impinges upon blades 80 of turbine 74 on opposite sides of turbine 74. Because nozzles 94 are carried by top cover 84 and directed generally inwardly relative to axis of rotation 82, the specific impingement angle of the pressurized fluid on blades 80 can easily be adjusted for a specific application. The angle of impingement, flow velocity of the pressurized fluid, shape of blades 80 and impingement location relative to axis of rotation 82 may be configured to provide a desired rotational speed of turbine 74.

Drive nut 98 includes internal threads which are threadingly engaged with external threads of turbine 74. Drive nut 98 includes an upper, angled surface 100 defining a fluid port for providing lubricating oil to bearings 76 and 78. Drive nut 98 includes a lower drive portion 102 with a cross sectional shape which is other than circular (e.g., hexagonal). The shape of lower drive portion 102 allows turbine 74 to interconnect with filter 72 and rotatably drive filter 72 during use. A flange 104 extends from drive portion 102 and seals with filter 72 around the outer periphery thereof with a slight compression fit.

Splash shield 106 is attached with housing 62 and directs oil away from filter 72 which is used to drive turbine 74. Splash shield 106 is press fit into housing 62 in the embodiment shown. Pressurized fluid in the form of oil which is used to drive turbine 74 falls via gravitational force and flows through holes 108 and into a trough 110 defined by splash shield 106. The trough 110 is connected with an exit port (not shown) in housing 62 for recirculating the fluid to the sump of the engine.

Filter 72 generally includes a body 112, end cap 114 and impingement media 116. Body 112 includes a top opening 118 which surrounds and frictionally engages flange 104 of drive nut 98. The press fit between flange 104 and top opening 118 is sufficient to prevent fluid leakage therebetween. Body 112 also includes a plurality of exit holes, such as the two exit holes 120 in the top thereof. Exit holes 120 allow filtered oil to flow therethrough and into trough 110 during operation after filter 72 is full of the oil to be filtered.

End cap 114 is attached with body 112 in a suitable manner. In the embodiment shown, end cap 114 and body 112 are each formed from plastic and are ultrasonically welded together. However, it is also possible to attach end cap 114 with body 112 in a different manner, such as through a threaded or snap lock engagement. End cap 114 includes an upwardly projecting stud 122 with an angled distal face which acts to radially distribute oil to be filtered which is ejected from central supply tube 96.

Impingement media 116, shown in more detail in FIG. 3, is in the form of a long, continuous sheet 124 of material which is wrapped in a spiral manner about supply tube 96 and stud 122. Sheet 124 can be flexible and/or formed out of a porous material, such as paper. Sheet 124 is formed with a plurality of randomly located dimples 126 which are approximately 3/16 inch diameter and 0.070 inch deep. Each dimple 126 defines a generally concave surface facing toward axis of rotation 82. Sheet 124 is approximately 0.020 inch thick and includes a plurality of holes 128 between dimples 126 which have a diameter of approximately 0.060 inch. Holes 128 are also substantially randomly placed on sheet 124 at locations between dimples 126 at a ratio of approximately one hole per every three dimples. In the embodiment shown, dimples 126 have a center-to-center distance which varies, but with a mean center-to-center distance of approximately ⅝ inch. Of course, it will be appreciated that the specific geometry and number of dimples 126 and/or holes 128 within sheet 124 may vary depending upon the specific application.

Impingement media 116 in the form of a spiral wrapped sheet with dimples 126 and holes 128 provides effective centrifugal separation of particulates within the oil, and also regulates the residence time of the oil within filter 72. As filter 72 rotates at a desired rotational speed during use, the oil to be filtered is biased radially outwardly against an adjacent portion of sheet 124. Particulates within the oil settle into the concave surfaces defined by dimples 126 and the filtered oil migrates toward a hole 128 to pass therethrough in a radial direction and impinge upon the next radially outward portion of sheet 124. The radially outward flow of the oil through holes 128 in sheet 124 and trapping of particulates within dimples 126 continues until the filtered oil lies against the inside diameter of body 112. An annular cap 130 at the end of spiral wrapped sheet 124 prevents the oil from prematurely exiting in an axial direction toward the end of filter 72. The filtered oil flows in an upward direction along the inside diameter of body 112 and through exit holes 120 into trough 110 to be transported back to the sump of the engine.

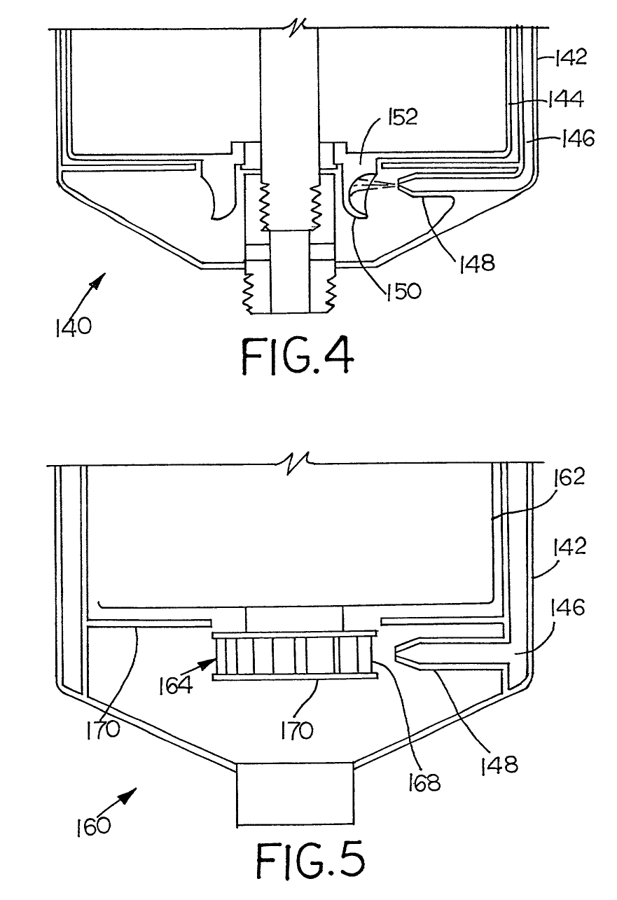

FIG. 4 illustrates yet another embodiment of a centrifugal filter assembly 140 of the present invention. Filter assembly 140 includes a housing 142 with a filter 144 rotatably disposed therein. Housing 142 includes an integral fluid channel 146 which terminates at a nozzle 148. Nozzle 148 directs pressurized fluid against turbine blades 150 of turbine 152.

Filter 144 includes turbine 152 as an integral part thereof. That is, turbine 152 is monolithically formed with filter 144. In the embodiment shown, filter 144 and turbine 152 are each formed at the same time using a plastic injection molding process.

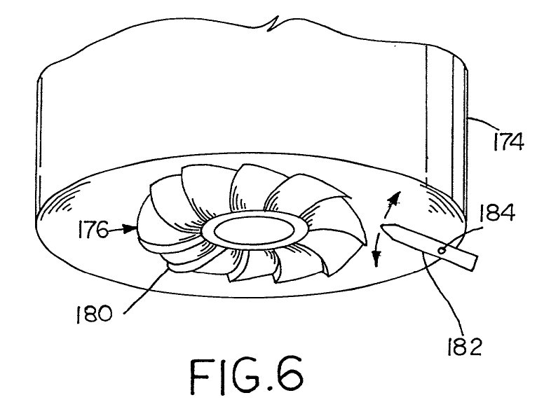

Referring now to FIG. 5, another embodiment of a centrifugal filter assembly 160 is shown, including a housing 142 and filter 162. Filter 162 includes a turbine 164 with a plurality of turbine blades 168. Turbine 164 includes a deflector shield 170 attached to an axial end thereof which maximizes the efficiency of the pressurized fluid jetted from nozzle 148 by confining sideways deflection of the fluid impinging on blades 168.

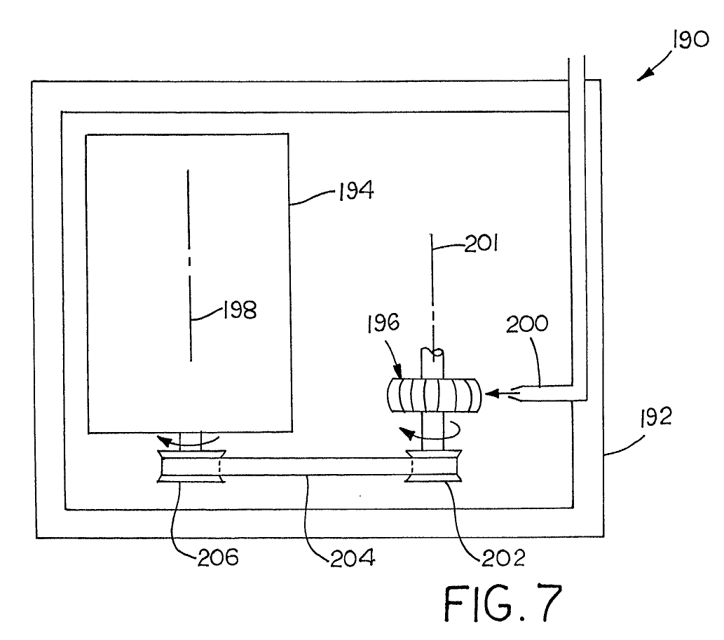

FIG. 6 illustrates another embodiment of a filter 174 which may be utilized with the centrifugal filter assembly of the present invention. Filter 174 includes a turbine 176 with a plurality of variable pitch turbine blades 180. A nozzle 182 which is attached with and pivotable relative to a housing (not shown) about a pivot point 184 is adjustable during use to change the impingement angle on blades 180 and the distance from the axis of rotation. The composite curved shape of each blade 180 coacts with the variable impingement angle from nozzle 182 to vary the rotational speed of and/or torque applied to turbine 176.

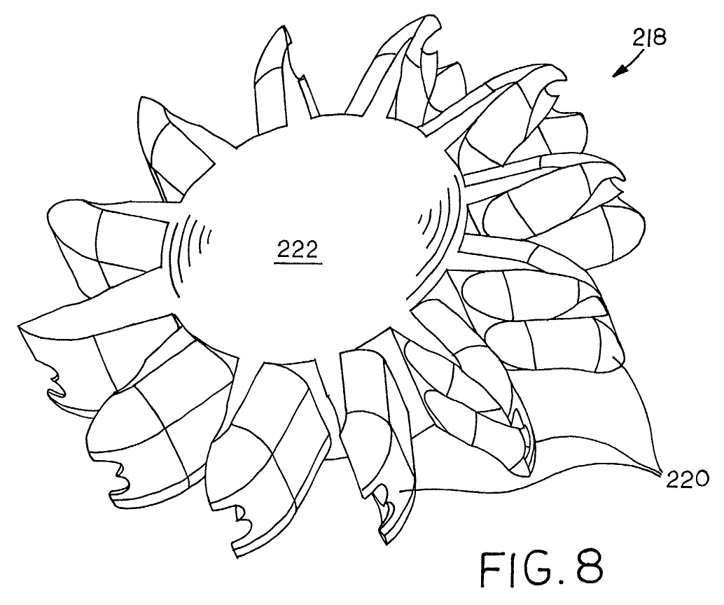

FIG. 7 illustrates yet another embodiment of a centrifugal filter assembly 190 of the present invention. Filter assembly 190 generally includes a housing 192, filter 194 and turbine 196. Filter 194 and turbine 196 are each disposed within housing 192 and are carried by suitable support structure (not shown) allowing rotation around respective axes of rotation 198 and 201. A nozzle 200 defined by housing 192 jets a flow of pressurized fluid onto turbine 196 to cause rotation thereof about axis of rotation 201. Rotation of turbine 196 in turn rotates pulley 202 which is connected via drive belt 204 with a pulley 206 rigidly attached to filter 194. Thus, rotation of turbine 196 causes rotation of filter 194 about axis of rotation 198. Using an elongate force transmission element, such as drive belt 204, allows the rotational speed of filter 194 to not only be adjusted by changing the physical configuration of turbine 196, but also by changing the diameters of the drive pulley 202 and driven pulley 206. For example, providing drive pulley 202 with a diameter which is the same as turbine 196 but twice as large as driven pulley 206 provides filter 194 with a rotational speed which is twice that of turbine 196.

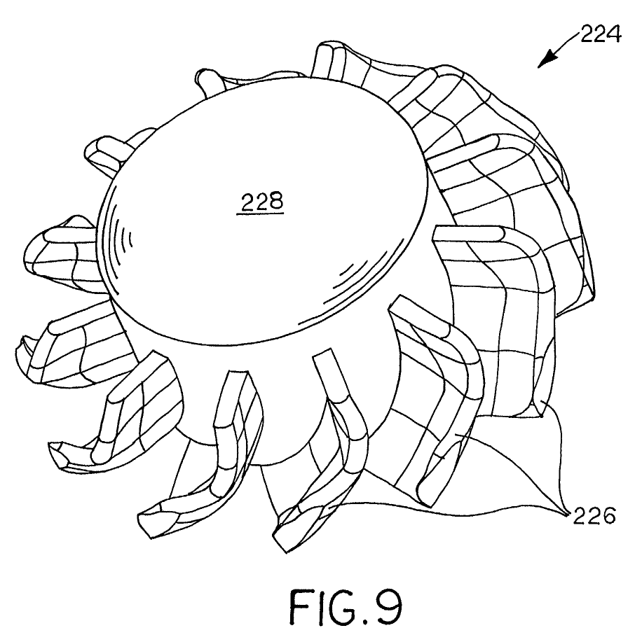

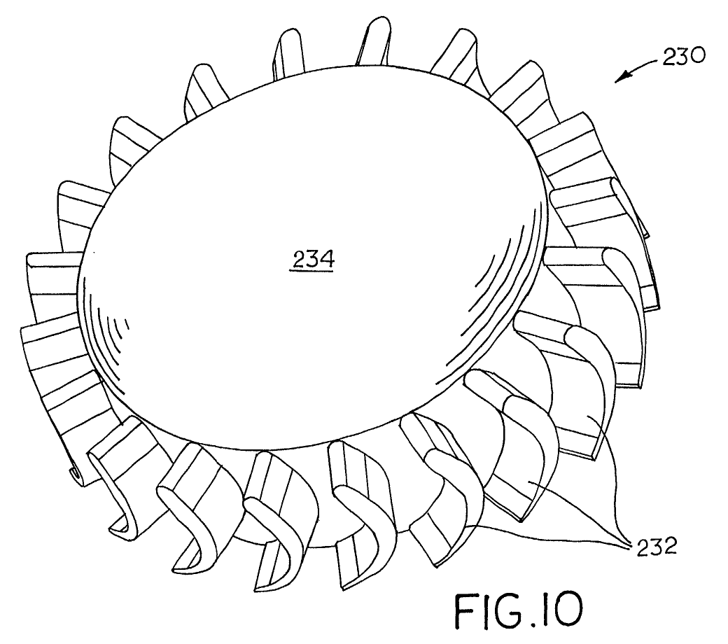

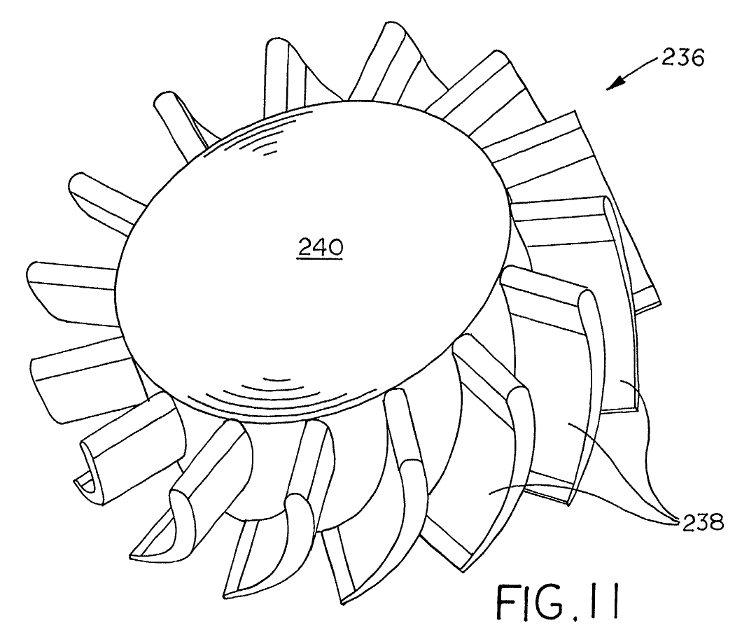

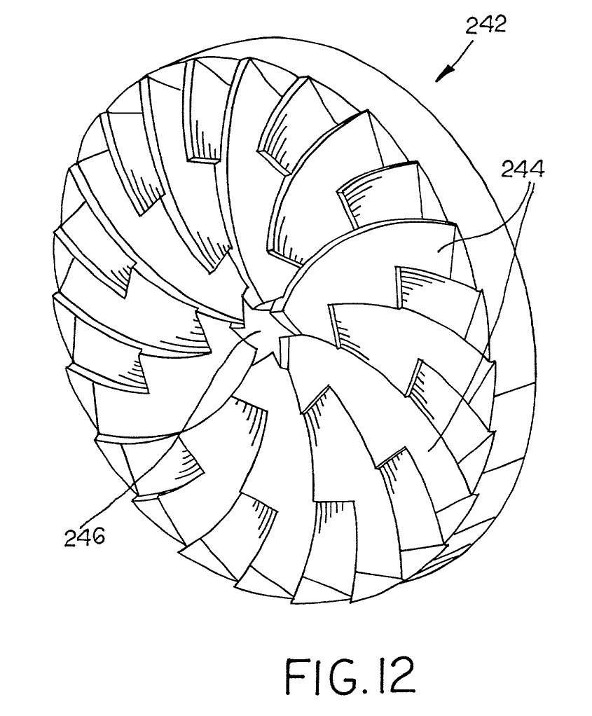

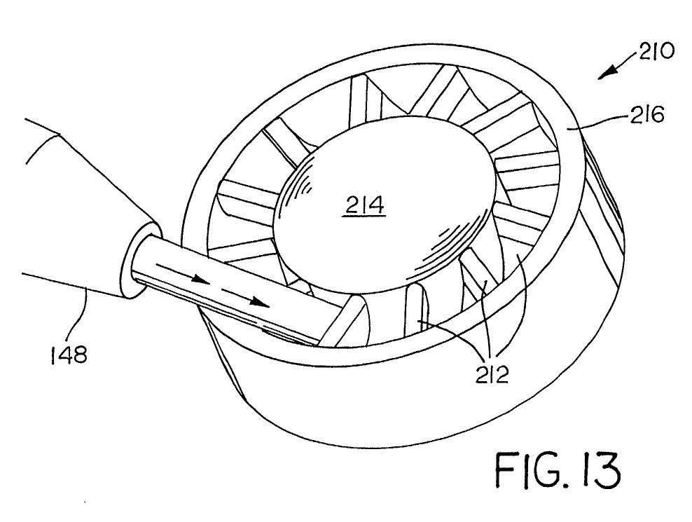

FIGS. 8-12 illustrate perspective views of alternative embodiments of turbines which may be used in a centrifugal filter assembly of the present invention. The turbines shown in FIGS. 8-11 are fixed blade designs for use with a stationary nozzle, while the turbine shown in FIG. 12 is a variable geometry design for use with an adjustable nozzle. Turbine 218 (FIG. 8) includes a plurality of turbine blades 220 extending radially from a hub 222. Turbine 224 (FIG. 9) includes a plurality of turbine blades 226 extending radially from a hub 228. Turbine 230 (FIG. 10) includes a plurality of turbine blades 232 extending radially from a hub 234. Turbine 236 (FIG. 11) includes a plurality of turbine blades 238 extending radially from a hub 240. Lastly, Turbine 242 (FIG. 12) includes a plurality of turbine blades 244 extending radially from a hub 246.

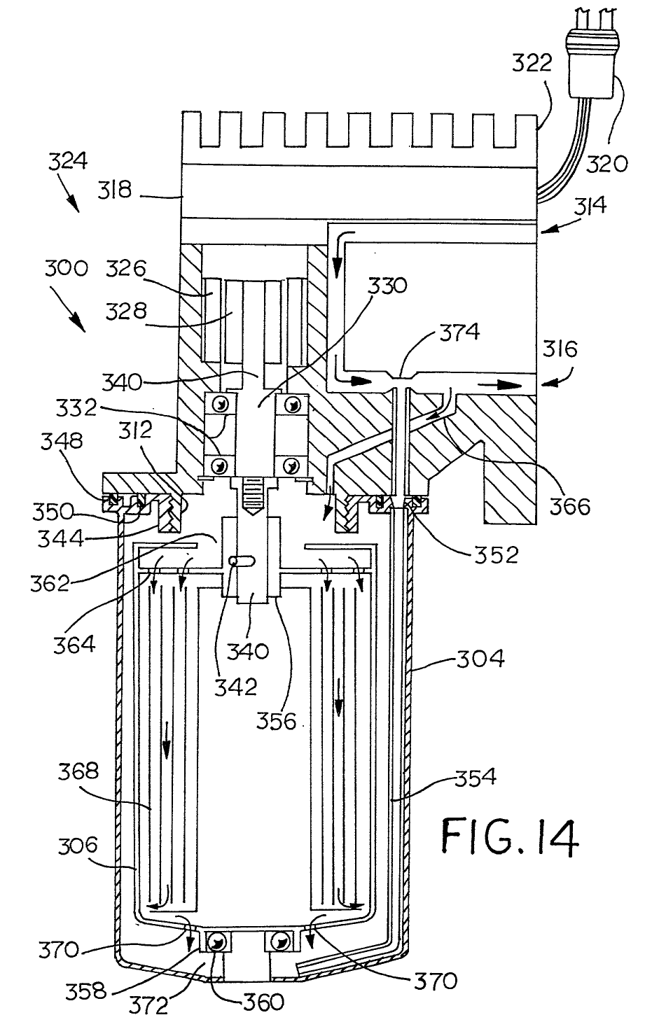

FIG. 13 is a perspective view of yet another embodiment of a turbine 210 which may be utilized with a centrifugal filter assembly of the present invention. Turbine 210 includes a plurality of turbine blades 212 extending radially from a hub 214. A deflector shield 216 surrounds the periphery of turbine 210 and contacts blades 212. For example, deflector shield 216 may be press fit onto turbine 210 around the periphery of blades 212. Deflector shield 216 maximizes the efficiency of the pressurized fluid which is jetted from a nozzle 148 by confining radial deflections of the fluid impinging on blades 212.

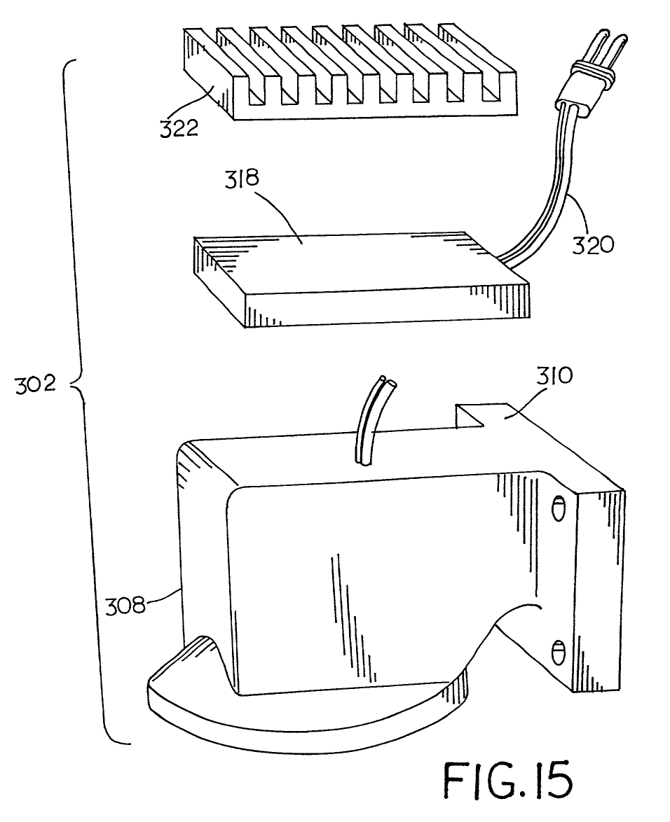

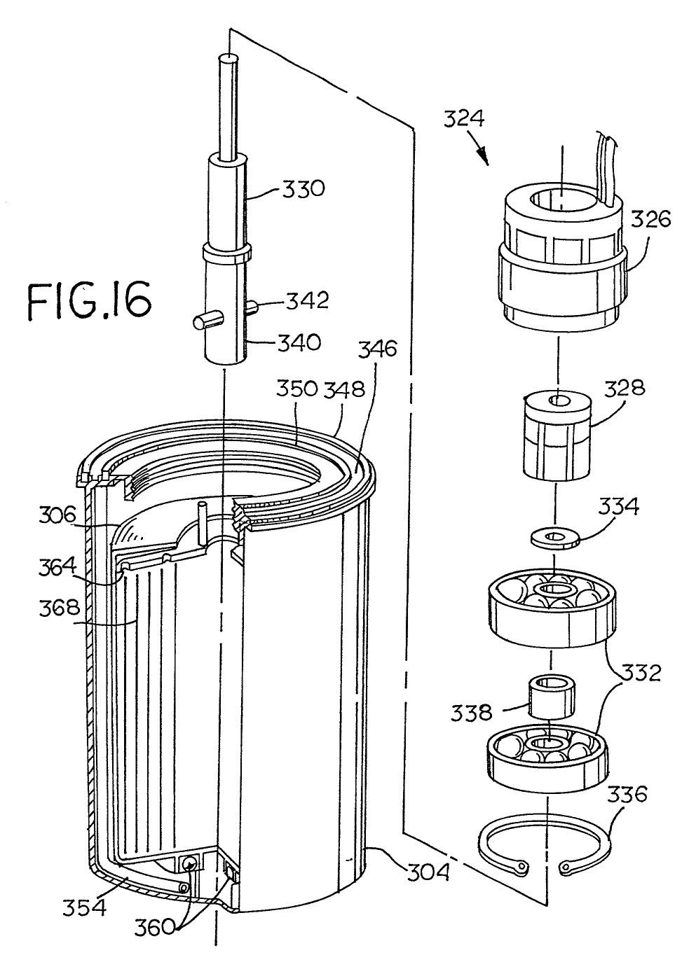

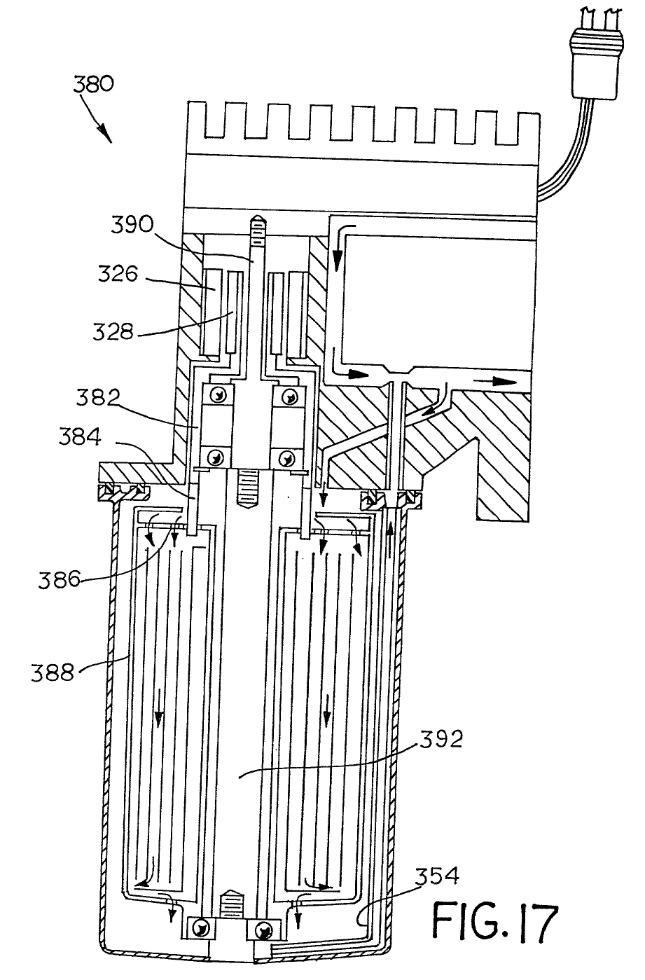

FIGS. 14-16 conjunctively illustrate another embodiment of centrifugal filter assembly 300 of the present invention, including a filter head 302, housing 304 and rotatable filter 306.

Filter head 302 includes a body 308 with a mounting flange 310 configured for connection with a source of oil to be filtered, such as an internal combustion engine. Body 308 includes a first threaded connector 312 for connection with housing 304, as will be described in more detail hereinafter. An inlet 314 receives oil from the internal combustion engine (not shown) and an outlet 316 returns oil to the internal combustion engine. In the embodiment shown, inlet 314 receives engine oil from an oil gallery which is pressurized to the rifle pressure within the oil gallery.

A controller 318 is connected to body 308 and controls operation of a DC brushless motor, as will be described hereinafter. Controller 318 may include a plugable cord 320 for attachment with a source of direct current power, such as an electrical system associated with the internal combustion engine. A heat sink 322 is attached to controller 318 for dissipating heat to the ambient environment. Heat sink 322 may be of any suitable configuration.

Filter head 302 also includes a brushless DC motor 324 which is carried by and disposed within body 308. DC motor 324 includes a brushless motor coil 326, a rotor 328 and an output shaft 330. Motor coil 326 is carried within a corresponding recess formed in body 308. Rotor 328 is press fit onto output shaft 330. Energization of motor coil 326 causes rotor 328 to rotate in known manner, which in turn causes output shaft 330 to rotate. Output shaft 330 may be carried by a pair of reduced friction bearings 332 disposed within body 308. Bearings 332 are located within body 308 using a bearing retainer 334 and a snap ring 336. A spacer 338 may be interposed between bearings 332 to maintain a proper axial spacing therebetween. Output shaft 330 includes a distal end defining a drive element in the form of a drive shaft 340 which is used to rotatably drive filter 306, as will be described in more detail hereinafter. Drive shaft 340 may include a drive pin 342 extending transversely therethrough which engages and drives filter 306.

Housing 304 is connected to filter head 302 in a suitable manner. In the embodiment shown, housing 304 includes a second threaded connector 344 which threadingly engages with first connector 312, and thereby attaches housing 304 with body 308. The threaded interconnection between first connector 312 and second connector 344 allows housing 304 to be attached with filter head 302 in a spin-on manner, thereby allowing easy removal and replacement of filter 306. Housing 304 may be connected to filter head 302 in other suitable ways, such as using a bolted flange, an annular V-shaped clamp surrounding adjacent flanges, an axial bolt, etc.

Housing 304 includes an open end 346, at which are disposed a pair of annular seals 348 and 350. An annular groove 352 is disposed between first annular seal 348 and second annular seal 350 at open end 346. A drain tube 354 disposed within and carried by housing 304 includes an open end which is disposed in communication with groove 352. An opposite open end of drain tube 354 is disposed in a bottom of housing 304. When housing 304 is connected with body 308, annular groove 352 is connected and disposed in communication with outlet 316 within body 308. Accordingly, drain tube 354 is also in communication with outlet 316 in body 308.

Filter 306 includes a hub 356 which engages with and is rotated by drive shaft 340. A hub 358 disposed at an opposite end from hub 356 allows filter 306 to be carried by a reduced friction bearing 360 at an end opposite from drive shaft 340. Filter 306 includes a major inlet 362 which is in the form of an annular opening surrounding hub 356. Filter 306 also includes a plurality of minor inlets 364. Each of major inlet 362 and minor inlets 364 are in communication with and receive oil to be filtered from a feed line 366 in filter head 302. Feed line 366 receives pressurized oil to be filtered, as will be described in more detail hereinafter.

Filter 306 also includes filter media 368 disposed therein which allows soot within the engine oil to be effectively filtered therefrom during rotation of filter 306. A plurality of outlets in the form of holes 370 formed in filter 306 allow the filtered oil to be drained from filter 306. The filtered oil collects in a sump area 372 where it is removed by the vacuum pressure created within drain tube 354.

During use, pressurized oil is transported through inlet 314 in body 308 of filter head 302. The pressurized oil flows to a venturi section 374 where the velocity of the oil increases and the pressure decreases. The reduced pressure caused by venturi section 374 creates a vacuum within sump 372 and drain tube 354 which allows the filtered oil within sump 372 to be drawn into the area of venturi section 374. As the oil flows past venturi section 374, the pressure again increases within outlet 316 in body 308. Pressurized oil is thus transported through a feed line 366 to major inlet 362 and minor inlets 364 of filter 306. The oil to be filtered flows through filter media 368. Brushless DC motor 324 rotates drive shaft 340 at a known rotational speed, which in turn rotates filter 306 within housing 304. The rotational speed of DC motor 324 is controlled using controller 318. The rotational speed of DC motor 324 is sufficient to filter soot from the engine oil flowing past media 368. The filtered oil flows through filter outlets 370 into sump 372. The filtered oil is then drawn through drain tube 354 to venturi section 374. The portion of the oil flowing past venturi section 374 which does not flow through feed line 366 instead flows in a parallel manner through outlet 316 to be returned to a sump in an internal combustion engine.

Venturi section 374 is a dual-function device that, in addition to removing filtered oil, removes air from sump 372. This creates a low pressure region around the rotating filter 306, thereby reducing air resistance or drag and increasing efficiency. More particularly, the operation of venturi section 374 reduces the current draw of DC motor 324 to less than 15 amperes.

Instead of venturi section 374, it is possible to use another type of vacuum or aspirating device, such as an ejector or eductor. Ejectors and eductors operate on the same Bernoulli principle as a venturi. However, where a venturi has a single entry port where one stream mixes with another stream, the ejector/eductor type devices mix the two streams with concentric passages, sometimes referred to as an annulus.

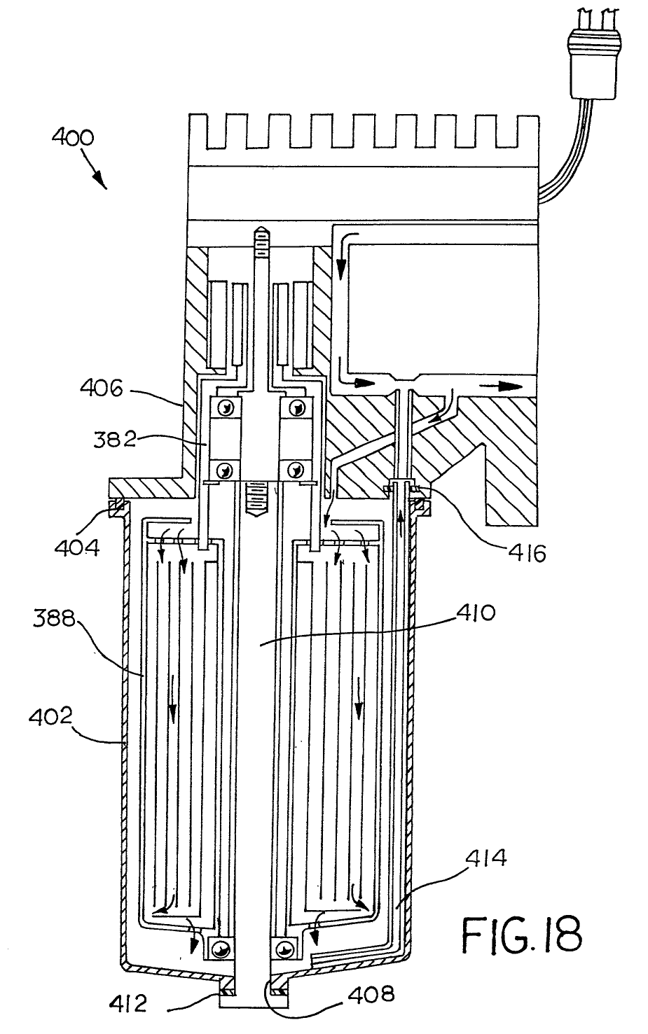

Referring now to FIG. 17, another embodiment of a centrifugal filter assembly 380 of the present invention is shown. Centrifugal filter assembly 380 principally differs from centrifugal filter assembly 300 in that rotatable drive element 382 is in the form of a drive cylinder driven by rotor 328 of DC motor 324. Drive cylinder 382 includes a plurality of drive projections or tangs 384 which extend into corresponding openings 386 formed in the top of filter 388. A stationary support shaft 390 is threadingly engaged with filter head 302. An opposite end of support shaft 390 is threadingly engaged with a support shaft 392 connected with housing 394.

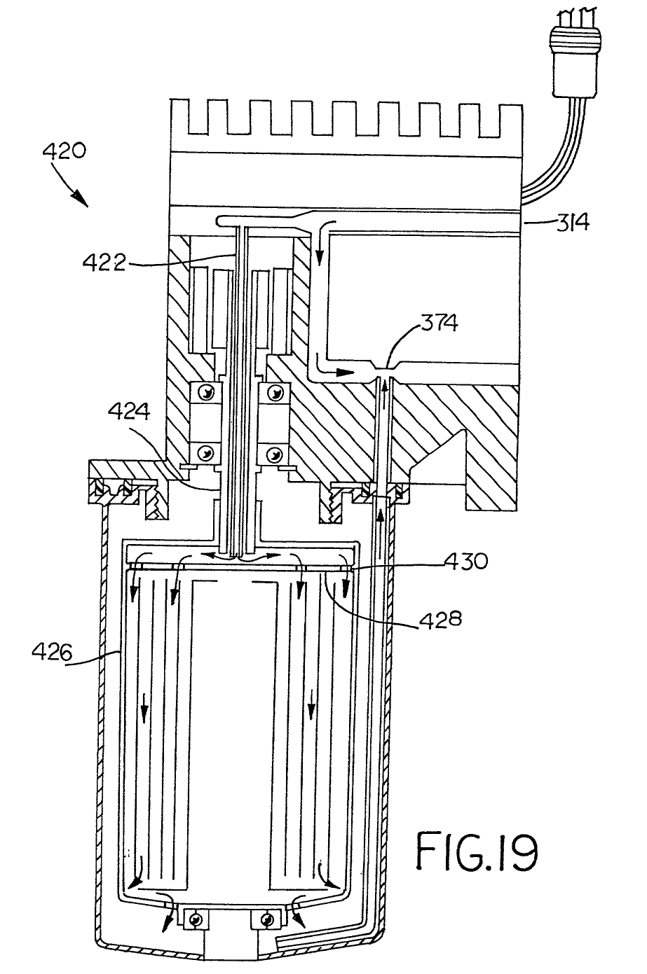

FIG. 18 illustrates another embodiment of a centrifugal filter assembly 400 of the present invention. Filter assembly 400 includes a drive cylinder 382 which engages a filter 388, similar to the embodiment of centrifugal assembly 380 shown in FIG. 17. However, housing 402 is not configured as a spin-on housing as in the embodiments of FIGS. 14-16 and 17. Rather, housing 402 includes a single annular seal 404 which abuts against filter head 406. An opposite end of housing 402 includes an opening 408 through which a support shaft 410 extends. A seal 412 is interposed between a head of support shaft 410 and housing 402 to seal therebetween. Housing 402 carries a drain tube 414. However, drain tube 414 extends past the sealing surface defined by seal 404. When housing 402 is engaged with filter head 406, drain tube 414 extends into a corresponding opening found in filter head 406. An O-ring 416 seals between drain tube 414 and filter head 406.

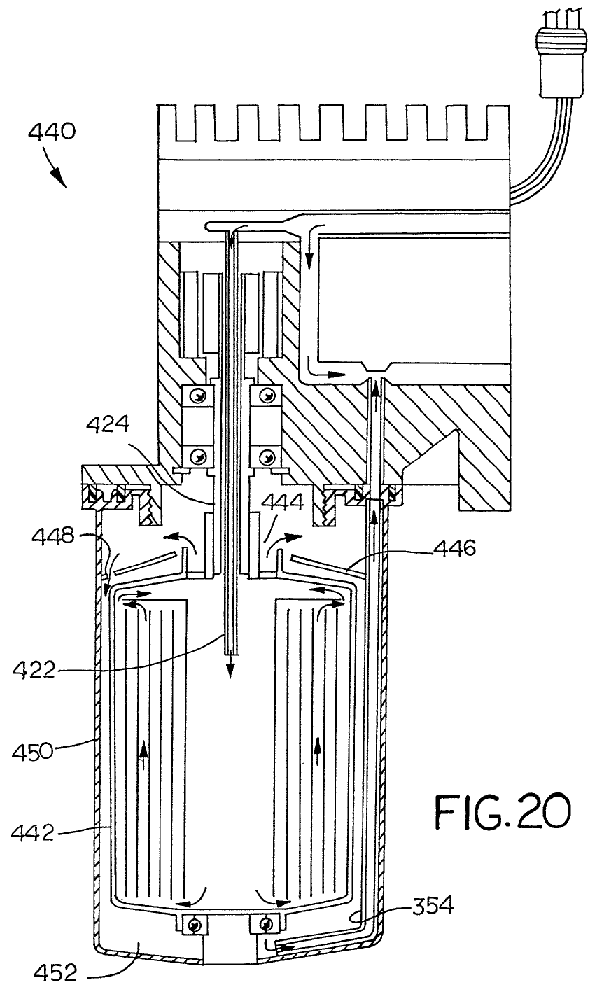

FIG. 19 illustrates yet another embodiment of a centrifugal filter assembly 420 of the present invention. Filter assembly 420 includes an oil feed line 422 which extends through the center of drive shaft 424. Drive shaft 424 carries and rotatably drives filter 426. Oil to be filtered which is transported through feed line 422 impinges upon a baffle disc 428 in the top of filter 426. Baffle 428 includes a plurality of inlets 430. Inlets 430 are disposed in communication with feed line 422, which in turn is connected with inlet 314 in filter head 432 at the upstream side of venturi section 374. This embodiment has the advantage of not recycling oil which has just been filtered back to inlets 430 of filter 426.

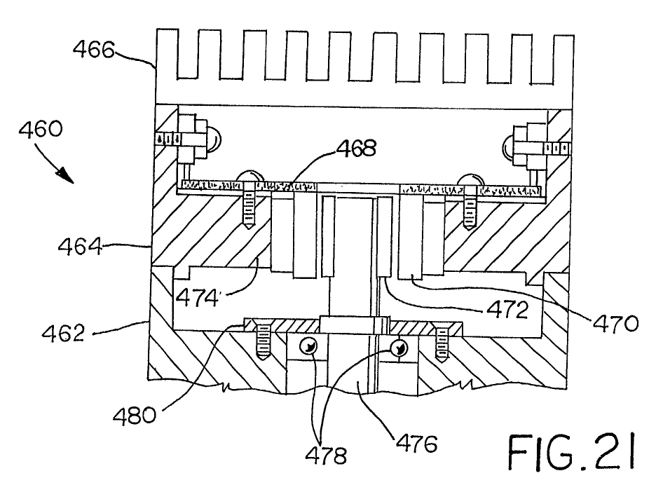

FIG. 20 illustrates yet another embodiment of a centrifugal filter assembly 440 of the present invention. Filter assembly 440 includes a feed line 422 which extends through the center of drive shaft 424, similar to the embodiment of centrifugal filter assembly 420 shown in FIG. 19. However, the oil is introduced directly into the center portion of filter 442. During rotation of filter 442, the oil is forced in a radially outward and upward direction for filtration of particulates such as soot therein. The oil then flows from a plurality of outlets 444 formed in the top of filter 442. The oil then flows over the top of a splash shield 446 and flows through a plurality of openings 448 adjacent housing 450. The oil then flows by gravitational force to a sump 452 where it is removed via the vacuum pressure created by drain tube 354.

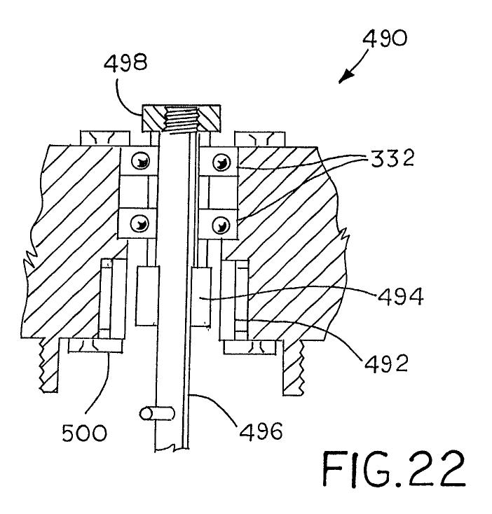

FIG. 21 illustrates a portion of a filter head 460 which may be used in a centrifugal filter assembly of the present invention. It will be appreciated that any of the embodiments of the centrifugal filter assembly shown in FIGS. 14-20 may be adapted to utilize filter head 460. Filter head 460 includes a body 462 which is attached to a controller 464. Controller 464 in turn is attached to a heat sink 466 for dissipating heat to an ambient environment. Controller 464 includes a printed circuit board 468 with suitable electronic circuitry which is necessary to control the rotational speed of a brushless DC motor including brushless motor coil 470 and rotor 472. Controller 464 includes a radially inwardly extending projection 474 which supports both printed circuit board 468 and brushless motor coil 470. Motor coil 470 and printed circuit board 468 are thus connected together via radially inwardly extending portion 474. Rotor 472 is carried by drive shaft 476, which in turn is supported by reduced friction bearing 478. A retainer disc 480 retains bearing 478 in place.

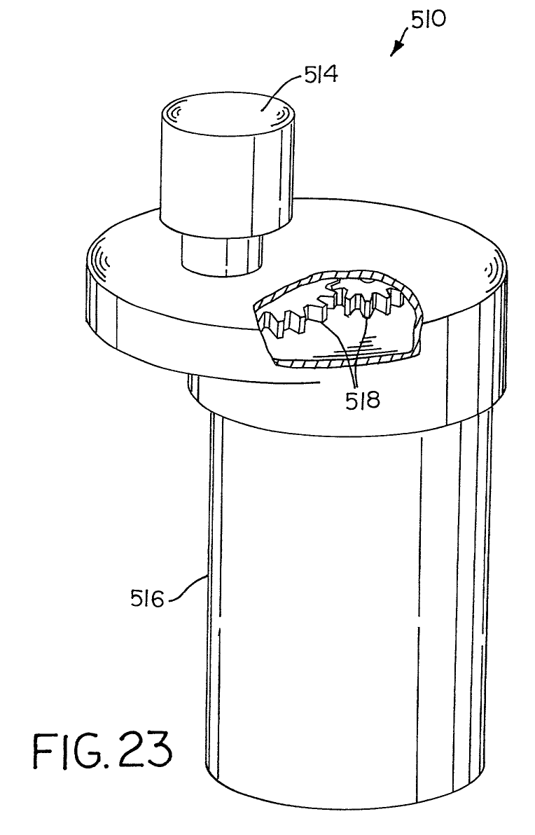

FIG. 22 illustrates a portion of another embodiment of a filter head 490 which may be used with a centrifugal filter assembly of the present invention. Filter head 490 includes a brushless DC motor with a motor coil 492 and a rotor 494 which are disposed adjacent to drive shaft 496. That is, motor coil 492 and rotor 494 are interposed between bearings 332 and drive shaft 496. A bearing retainer nut 498 retains bearings 332 in place; and a motor retainer disc 500 retains motor coil 492 and rotor 494 in place.

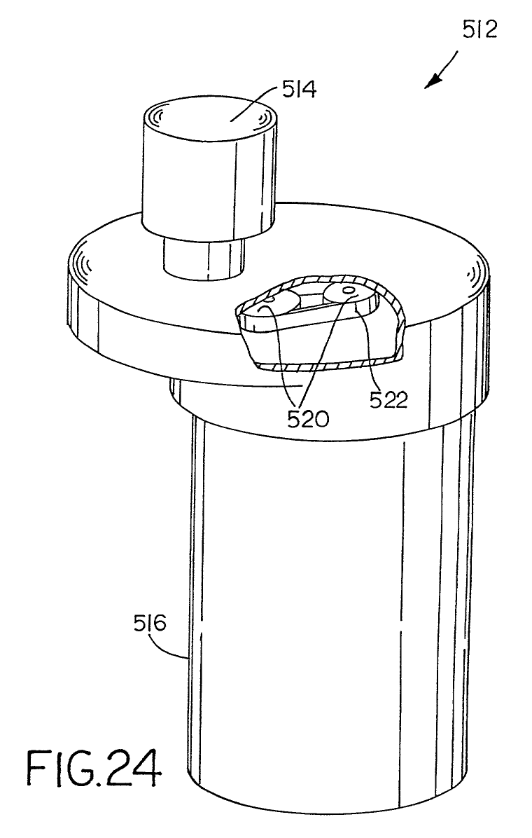

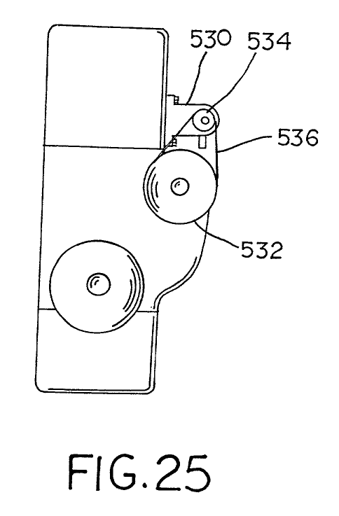

FIGS. 23 and 24 illustrate further embodiments of centrifugal filter assemblies 510 and 512 of the present invention, respectively. Each filter assembly 510 and 512 includes a motor 514 which may be in form of a brushless DC motor, a hydraulic motor, pneumatic motor, etc. Likewise, each filter assembly 510 and 512 includes a housing 516 which rotatably supports a filter (not shown) therein. Filter assembly 510 includes a gear train with a plurality of gears 518 which are sized to provide a desired rotational speed of the filter within housing 516. Similarly filter assembly 512 includes a plurality of pulleys 520 driven by a common belt 522. Pulleys 520 are sized to provide a desired rotational speed of the filters disposed within housing 516.

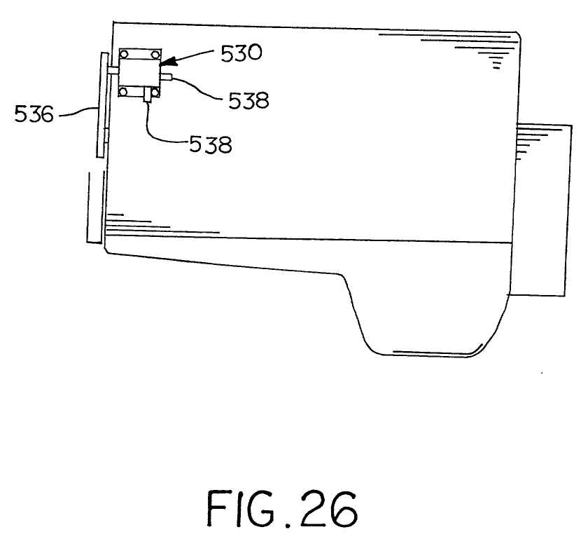

FIGS. 25 and 26 disclose an embodiment of an accessory power source 530 which may be utilized in conjunction with an accessory drive system including an accessory drive pulley 532 of an internal combustion engine. Power source 530 includes an input pulley 534 which is connected via an accessory drive belt 536 with accessory drive pulley 532. Power source 530 includes one or more output shafts 538 which may be used to drive a centrifugal filter assembly of the present invention. In the embodiment shown in FIGS. 25 and 26, power source 530 includes two rotatable output shafts 538 which are respectively oriented in a horizontal and a vertical direction so that a selected output shaft may be easily connected with a centrifugal filter assembly of the present invention. Of course, power source 530 may include appropriate intermediate gearing therein (not shown) to adjust the rotational output speed of output shafts 538.

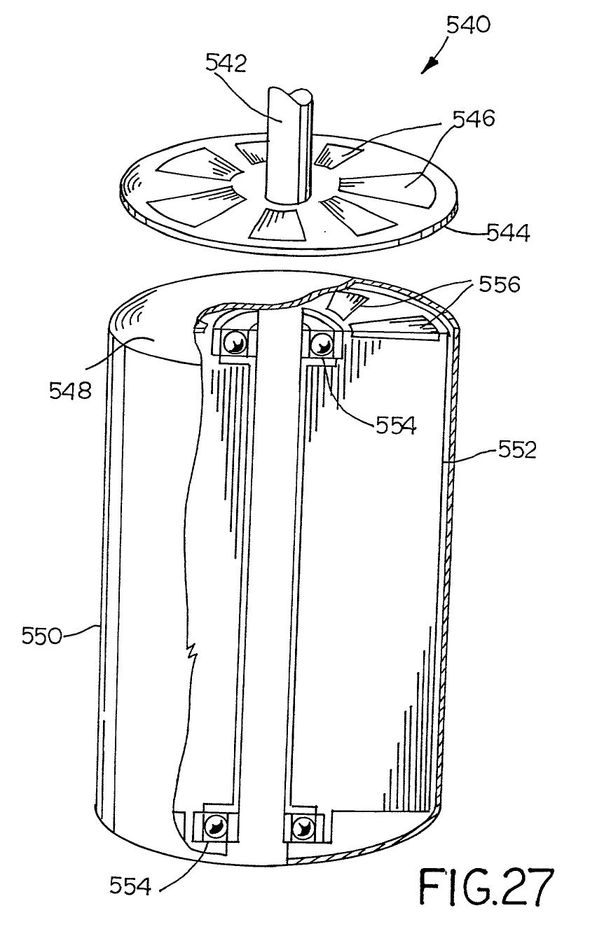

FIG. 27 illustrates yet another embodiment of a centrifugal filter assembly 540 of the present invention. Filter assembly 540 includes a drive shaft 542 which may be connected with a source of power, such as a brushless DC motor. Drive shaft 542 in turn is connected with a disk 544 which carries a plurality of permanent magnets 546. Disk 544 is positioned axially adjacent to an end 548 of a housing 550. Housing 550 rotatably carries a filter 552 therein, such as by using bearings 554. Filter 552 also carries a plurality of permanent magnets 556 which are positioned adjacent to end 548 on a side opposite from disk 544. End 548 of housing 550 is formed from a non-magnetic material so that magnetic fields generated by each of magnets 546 and 556 may affect each other. During use, drive shaft 542 is rotated which in turn rotates disk 544. Rotation of permanent magnets 546 forms a rotating electromagnetic field which exerts a coupling force on permanent magnets 556 carried by filter 552. Filter 552 thus rotates within housing 550.

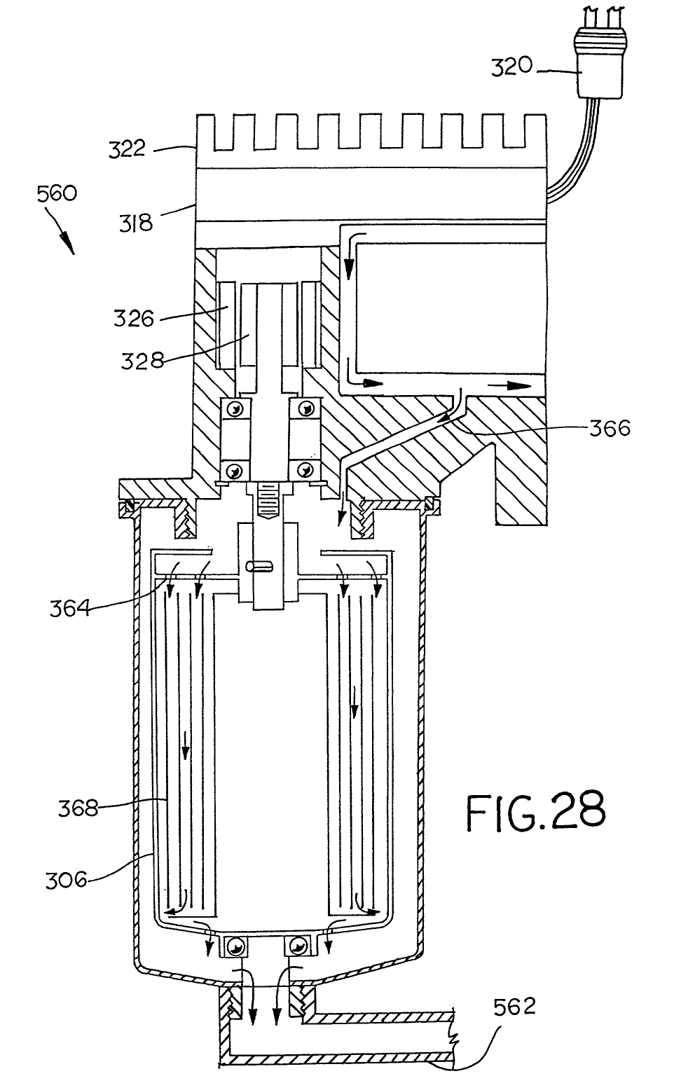

FIG. 28 illustrates a further embodiment of a centrifugal filter assembly 560 of the present invention. Centrifugal filter assembly 560 is similar to the embodiment of centrifugal filter assembly 300 shown in FIG. 14. However, centrifugal filter assembly 560 includes a gravity drain 562, rather than a venturi which siphons oil through a drain tube.

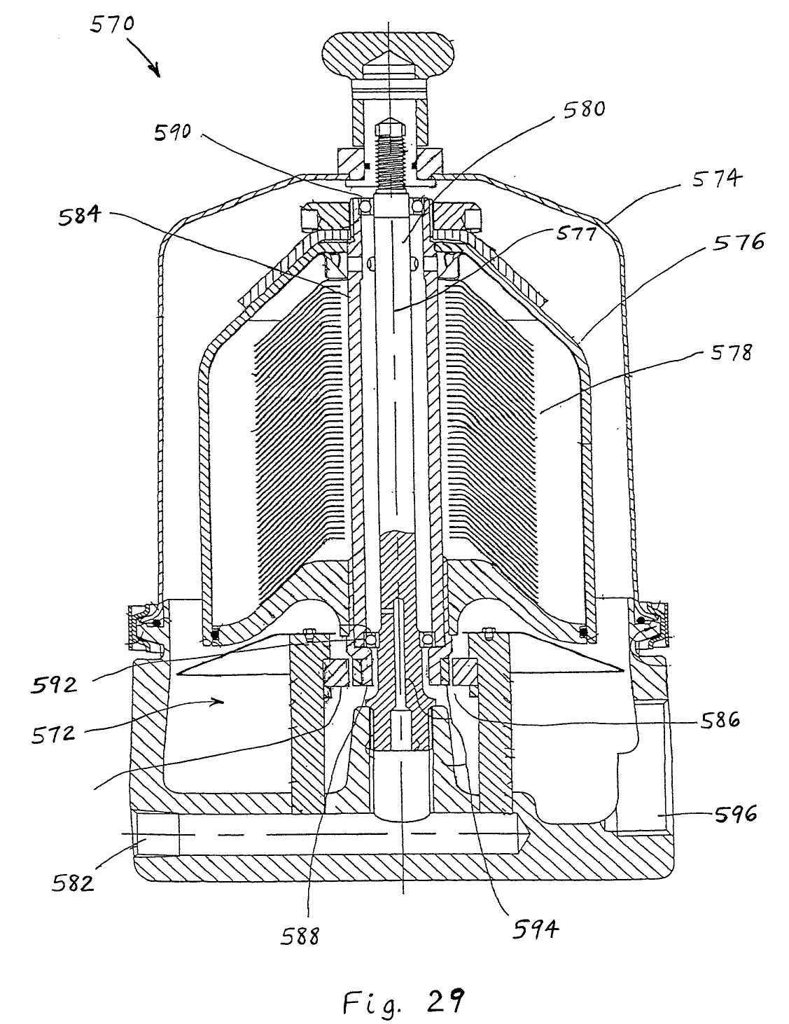

Another embodiment of a centrifugal filter assembly 570 for filtering particulates from a fluid, for example, filtering soot from engine oil in a diesel engine, is shown in FIG. 29. Centrifugal assembly 570 may be used for other applications, such as a medical application for separating particulates from a bodily or medical fluid, or machining and cutting applications for separating metallic particles from a hydraulic fluid or lubricating oil. Additionally, centrifugal filter assembly 570 may be used to separate fluids of different densities, such as a fuel-water or oil-water filtration system.

Centrifugal filter assembly 570 generally includes a brushless direct current motor 572, a non-rotating filter housing 574 including an attached base housing, and a rotatable filter element 576. Filter element 576 rotates about an axis of rotation 577. The cone-stack filter media 578 is contained within rotating filter element 576. Cone-stack filter media 578 increases the filtration surface area and improves the filtration efficiency. Liquid to be filtered enters the rotating filter element 576 through a central non-rotating shaft 580 at entrance 582. A rotating filter central rotating cylinder 584 is rigidly connected to an electric motor rotor 586 by a magnet housing 588. The rotating cylinder 584 is connected to the non-rotating shaft 580 by upper bearing 590 and lower bearing 592. The magnet housing 588 contains motor rotor magnets 594.

A stationary set of motor coils is attached to non-rotating filter housing 574. An electric current is supplied to the motor coils, creating an electromagnetic interaction between the coils and magnets 594. The resultant torque causes motor rotor 586 to rotate at speeds between 4,000 and 25,000 revolutions per minute (RPM), depending on temperature and engine operating conditions. For example, rotor 586 may rotate at a speed closer to 4,000 RPM when a temperature of assembly 570 has risen to a predetermined level, which may be determined by a temperature sensor (not shown). Rotor 586 may also rotate at the reduced speed when a vehicle on which assembly 570 is installed is at idle, which reduces any cooling air currents across assembly 570. As the liquid travels through rotating filter element 576, soot and other particulate matter are separated from the bulk fluid by the centrifugal force and are trapped by the cone-stack element. Filtered fluid exits the rotating element 576 through drillings in the rotating element base and returns to the engine sump through exit 596. Motor 572 rotates filter assembly 570 by virtue of motor rotor 586 and magnets 594 being rigidly attached to rotating cylinder 584, with the stationary motor coils surrounding rotor magnets 594.

It is possible to replace motor 572 with many other types of drive mechanisms, including a belt-driven system, a gear-driven system, a mechanism driven by an engine's exhaust gas, and a pressurized air source.

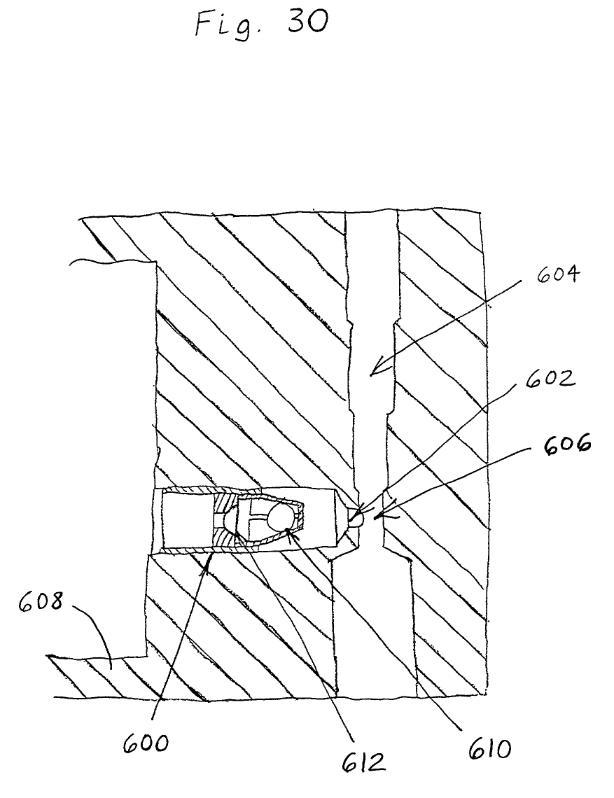

In another embodiment, a set of three valves allows the filter of the present invention to be used on a vehicle by controlling the oil flow through the system. A first of the three valves is a check ball valve 600 (FIG. 30) that allows oil to flow one way through an aspiration port 602 of a venturi 604. Venturi 604 does not begin to draw a vacuum until the oil has reached a certain temperature, e.g., 100 degrees F. Thus, at temperatures below that certain temperature, check ball value 600 prevents oil from flowing from a throat 606 of venturi 604, through aspiration port 602, and into a filter housing 608, thus flooding filter housing 608. Once venturi 604 begins to draw a vacuum, a check ball 610 moves off of its seat 612, and filter housing 608 is evacuated.

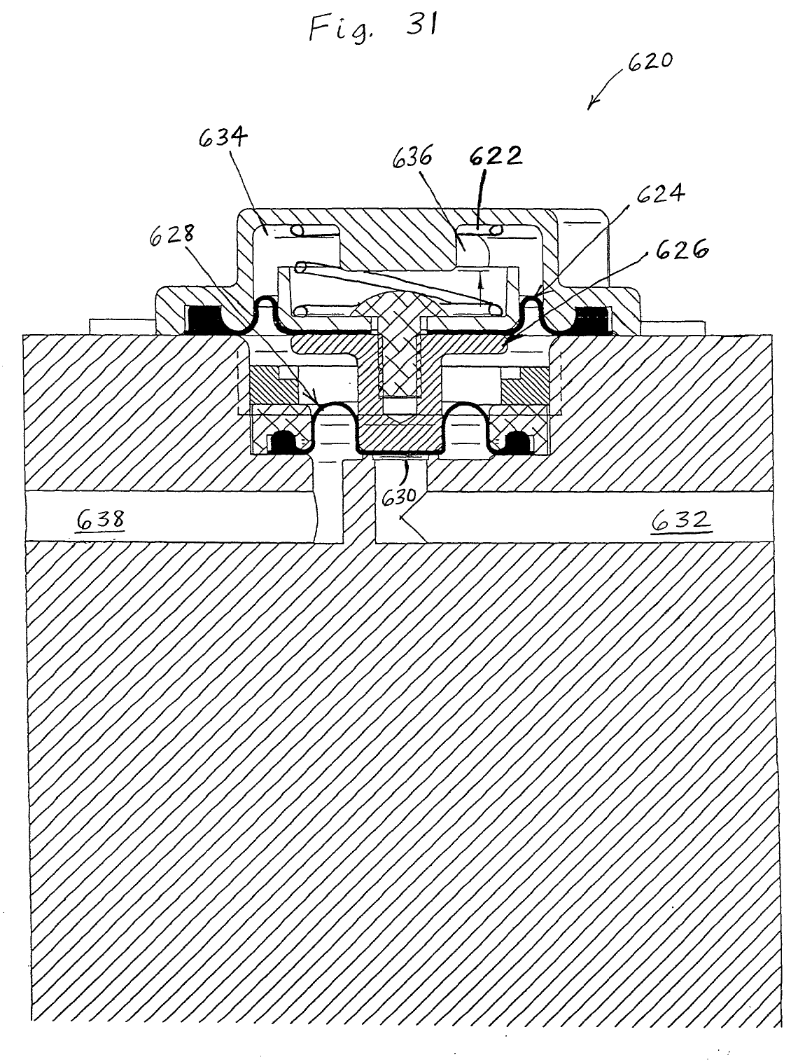

A second valve 620 (FIG. 31) controls when the oil begins to flow into the rotating element. The rotating element is designed to not drain oil until oil is flowing into it, even when the rotating element is not spinning. Therefore, as soon as oil flow into the rotating element stops, flow out of the rotating element stops. Conversely, as soon as oil flow into the rotating element begins, flow out of the rotating element begins. Since the venturi doesn't begin aspirating immediately, if oil was allowed to flow into the rotating element immediately, the resulting flow out of the rotating element would flood the filter housing. Oil valve 620 does not allow oil to flow into the rotating element until the vacuum inside the filter housing has reached a certain level, e.g., about 15 inches Hg.

Under atmospheric conditions, a spring 622 pushes against an actuating diaphragm 624 which pushes against a plunger 626. Plunger 626 forces a sealing diaphragm 628 against an oil port 630, preventing oil flow from an oil supply 632. When the venturi begins to draw a vacuum, an actuation chamber 634 is evacuated through a vacuum port 636. When the vacuum is great enough, the force of spring 622 is overcome and sealing diaphragm 628 is lifted off of oil port 630, allowing oil to flow out through oil drilling 638 and into a rotating element.

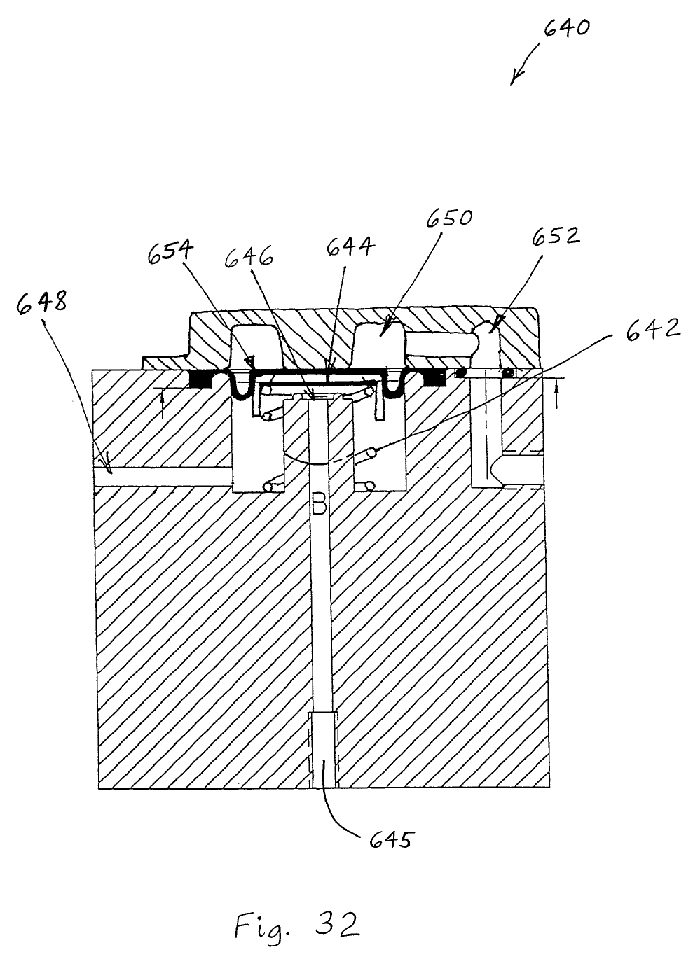

A third valve is used to vent the filter housing to atmosphere upon loss of oil pressure. If oil pressure is lost, then the venturi stops aspirating. If the vacuum in the filter housing is not vented, then oil will be drawn into the filter housing until the pressure differential across the oil supply line is equalized, thereby flooding the filter housing. A vent valve 640 for venting the filter housing is shown in FIG. 32. Under atmospheric conditions, a spring 642 forces a seal 644 off of a vent port 646 and the filter housing is vented through line 645 and vent line 648. When oil pressure is realized in an actuation chamber 650 through an oil passage 652, an actuating diaphragm 654 forces seal 644 against vent port 646, and vent line 648 is sealed.

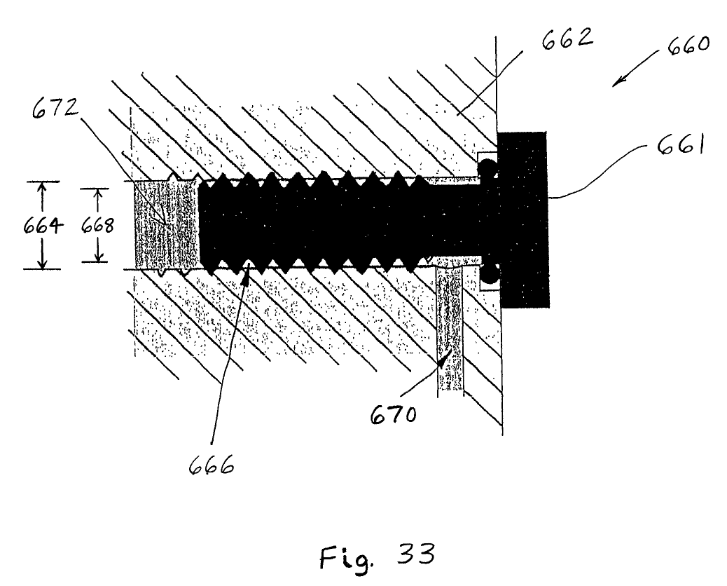

A low flow rate of oil through the filter of the present invention, and a correspondingly high residence time of the oil within the filter, allows the filter to operate effectively. This low flow rate and high residence time is achieved by use of a threaded oil flow restrictor 660 (FIG. 33) in the form of a bolt 661 that threads into an internal thread of a channel in filter housing 662. A minor diameter 664 of the internal thread is drilled significantly oversize so that there is only a portion of the bolt thread that radially engages the internal threads. A corresponding gap 666 between the minor diameter 664 of the internal thread and the minor diameter 668 of the bolt thread provides a flow path for the oil that is plumbed into the rotating can. By flowing the oil around the threads of bolt 661, a long flow path of small flow area is achieved in a very compact package. The desired pressure loss, and therefore flow restriction, is achieved by lengthening or shortening bolt 661. Oil enters flow restrictor 660 through an oil supply drilling 670, flows through the inter-thread gap 666, and exits through an oil outlet 672.

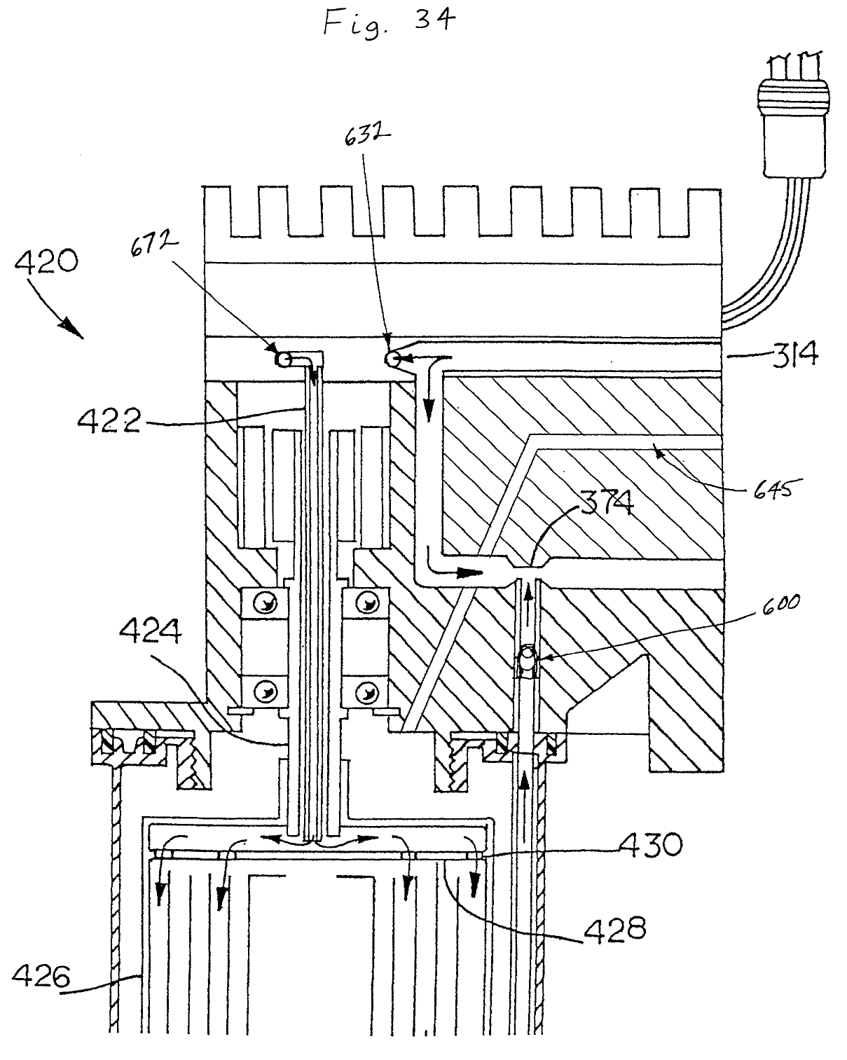

The locations of check ball valve 600, oil supply 632, line 645 and oil outlet 672 within a filter assembly of the present invention, such as filter assembly 420, are shown in FIG. 34. It is to be understood that check ball valve 600, valve 620, vent valve 640 and flow restrictor 660 can also be included in other embodiments of a filter assembly that are disclosed herein.

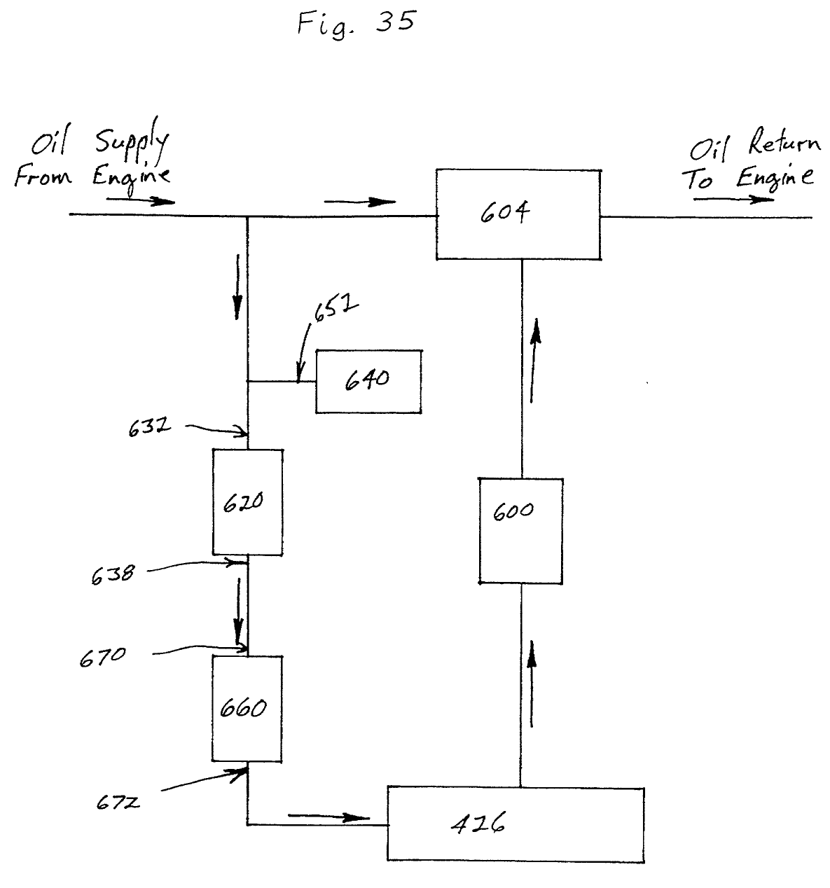

FIG. 35 is a diagram of the flow of engine oil through and between check ball valve 600, valve 620, vent valve 640 and flow restrictor 660.

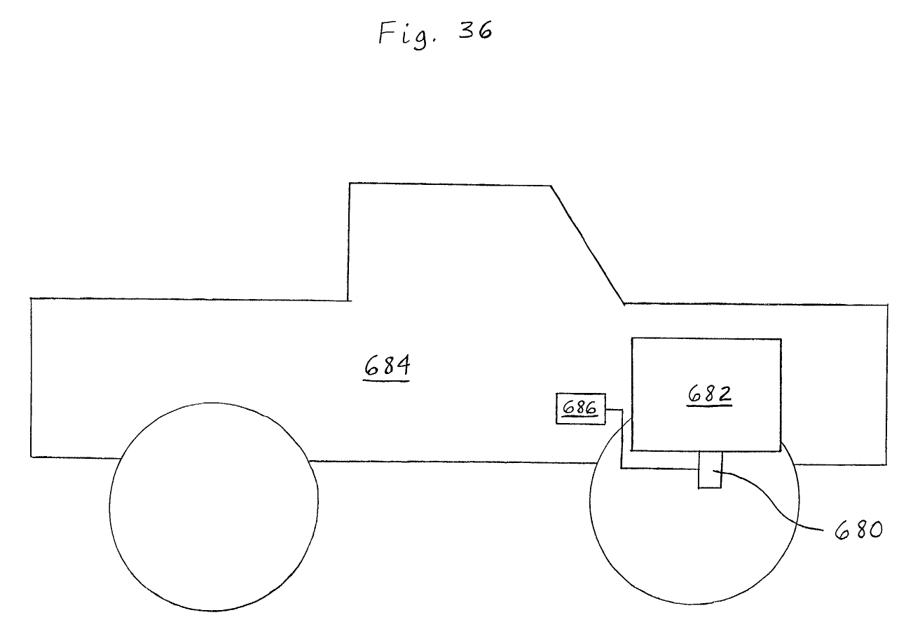

A motor driven centrifugal filter assembly 680 (FIG. 36) can be attached to an engine, such as a diesel engine 682, of a truck 684. Filter assembly filters a fluid of engine 682, such as engine oil or coolant. Any embodiment of a centrifugal filter assembly disclosed herein may also be similarly attached to a truck engine.

A digital motor controller 686, such as a digital signal processor, can be used to control filter assembly 680. Digital motor controller 686 is capable of monitoring the motor input current and commanding a duty cycle which maintains a maximum allowable current. Current monitoring is accomplished by measuring the voltage drop across a shunt resistor, but this can also be accomplished in other ways, including commercially available current sensing devices, such as the Zetex ZMC20. The maximum allowable current is programmed into controller 686, or it can be changed by external inputs or by internal algorithms.

Digital motor controller 686 is capable of monitoring the rotational speed of the motor and commanding a duty cycle which maintains a maximum allowable rotational speed. The maximum allowable rotational speed can be programmed into controller 686, or it can be changed by external inputs or by internal algorithms.

Digital motor controller 686 can monitor its operating temperature and command a duty cycle which maintains the operating temperature under a maximum allowable operating temperature. Temperature is monitored by a National Semiconductor LM34DZ, but this can also be accomplished with a thermocouple or an RTD. Digital motor controller can communicate with external devices over a J1939 datalink connection. The communication is accomplished by an internal CAN module, but an external CAN module can also be used. The datalink can be used to monitor transmissions from other devices, or it can be used to transmit information to other devices.

Digital motor controller 686 can monitor startup parameters and delay and/or ramp startup accordingly. The startup parameters can include, but are not limited to, engine speed, engine oil pressure, and engine oil temperature.

Digital motor controller 686 can monitor engine operating conditions over the J1939 datalink and adjust the filter operating conditions accordingly. The engine can also command filter operating conditions over the J1939 datalink.

Digital motor controller 686 can detect problems in the operation of the centrifugal filter and log a fault code. The fault code can be transmitted to the vehicle over J1939, and a fault light can be illuminated to alert the driver to the problem. A technician can than troubleshoot the centrifugal filter using a PC based service tool.

Controller 686 has been disclosed herein as being a digital controller. However, it is to be understood that controller 686 can also be in the form of analog electronics.

Filter assembly 680 has been disclosed herein as being attached to engine 682. However, filter assembly 680 can also be in the form of a remote-mount filter located on the vehicle or frame rail.

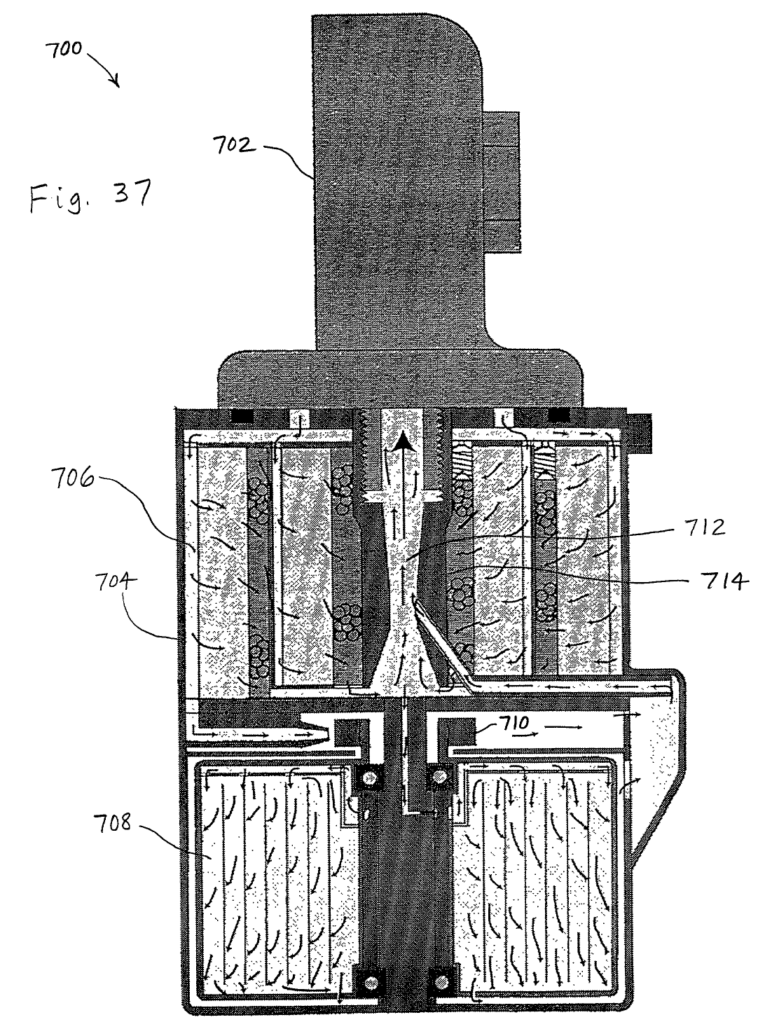

Another embodiment of a turbine driven centrifugal filter assembly 700 (FIG. 37) includes a filterhead 702 and a monolithic housing 704 containing a full flow filter 706 and a centrifugal filter 708. Centrifugal filter 708, whose rotation is driven by an integral turbine 710, removes all particulate matter that passes through the bypass section, including soot particles measuring as small as 0.1 micron and only slightly greater in specific gravity than oil. Approximately 0.75 to 1.0 gpm oil flow from the engine oil gallery drives turbine 710 for rotation of centrifugal filter 708. An integral venturi section 712 inside a center tube 714 in full flow filter 706 is used to aspirate the turbine drive oil back into the gallery oil circuit. Venturi section 712 also removes air from the space between centrifugal filter 708 and housing 704, thus enabling filter 708 to rotate in a vacuum. The venturi neck inlet is plumbed to the drain section of the turbine housing whereby the turbine activation oil is aspirated back into the gallery flow.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A centrifugal filter assembly for filtering particulates from a fluid medium, said assembly comprising:
a non-rotating filter housing;
a filter disposed within said housing, said filter being rotatable relative to said housing about an axis of rotation, said filter having an inlet and an outlet for the fluid medium;
filter media disposed within said filter; and
a drive mechanism configured for rotating said filter.

2. The assembly of claim 1, wherein said filter media comprises a cone-stack.

3. The assembly of claim 1, wherein said filter media is configured for increasing a filtration surface area and improving filtration efficiency.

4. The assembly of claim 1, wherein said drive mechanism comprises an electric motor.

5. The assembly of claim 4, wherein said electric motor comprises a brushless direct current motor.

6. The assembly of claim 1, wherein said filter media is replaceable.

7. The assembly of claim 1, further comprising a fixed shaft substantially concentric with the axis of rotation.

8. The assembly of claim 1, further comprising a rotatable shaft substantially concentric with the axis of rotation.

9. A centrifugal filter assembly for filtering particulates from a fluid medium, said assembly comprising:
a non-rotating filter housing;
a filter disposed within said housing, said filter being rotatable relative to said housing about an axis of rotation, said filter having an inlet and an outlet for the fluid medium;
a drive mechanism configured for rotating said filter; and
an electrical controller configured for adjusting a rotational speed of said filter.

10. The assembly of claim 9, wherein said controller comprises a digital signal processor.

11. A motor vehicle, comprising:
an engine containing a fluid medium; and
a centrifugal filter assembly for filtering particulates from the fluid medium, said assembly comprising:
a non-rotating filter housing;
a filter disposed within said housing, said filter being rotatable relative to said housing about an axis of rotation, said filter having an inlet and an outlet for the fluid medium; and
a drive mechanism configured for rotating said filter.

12. The motor vehicle of claim 11, further comprising an electrical controller configured for adjusting a rotational speed of said filter.

13. The motor vehicle of claim 12, wherein said controller is configured for adjusting the rotational speed of said filter based on at least one vehicle operating condition, said at least one vehicle operating condition comprising at least one of engine speed, engine oil pressure, and engine oil temperature.

14. A centrifugal filter assembly for filtering contaminants from a fluid medium, comprising:
a housing;
a filter disposed within said housing and rotatable relative to said housing about an axis of rotation, said filter having an inlet and an outlet for the fluid medium;
a vacuum device in communication with said outlet, said vacuum device configured to create a vacuum within said housing for drawing at least one of the fluid medium and air through said outlet; and
a drive mechanism having a rotatable output shaft coupled with said filter for rotating said filter about said axis of rotation.

15. The centrifugal filter assembly of claim 14, wherein said vacuum device comprises a venturi section.

16. The centrifugal filter assembly of claim 14, wherein said drive mechanism comprises an electric motor.

17. The centrifugal filter assembly of claim 16, wherein said electric motor comprises a brushless DC electric motor.

18. The centrifugal filter assembly of claim 14, wherein said vacuum device is configured to create a vacuum within said housing for drawing the fluid medium and air through said outlet.

19. The centrifugal filter assembly of claim 14, wherein the fluid medium comprises an engine fluid.

20. The centrifugal filter assembly of claim 19, wherein the engine fluid comprises engine oil.

21. The centrifugal filter assembly of claim 14, further comprising a filter head connected with said housing, said vacuum device being at least one of attached to and disposed within said filter head.

22. The centrifugal filter assembly of claim 14, further comprising a replaceable filter medium disposed within said filter.

23. The centrifugal filter assembly of claim 14, further comprising a check valve disposed between said vacuum device and said outlet, said check valve being configured for preventing the fluid medium from flowing from said vacuum device to said outlet.

24. The centrifugal filter assembly of claim 14, further comprising a fluid flow control valve in fluid communication with said vacuum device, said fluid flow control valve being configured for preventing flow of the fluid medium through said filter until said vacuum device creates the vacuum.

25. The centrifugal filter assembly of claim 14, further comprising a vent valve in fluid communication with said housing, said vent valve being configured for venting said housing to atmosphere upon a loss of fluid pressure.

26. The centrifugal filter assembly of claim 14, wherein said housing includes a channel for the fluid medium, said filter assembly further comprising a fluid flow restrictor at least partially disposed within said channel, said fluid flow restrictor being configured for restricting a flow of the fluid medium through said channel.

27. The centrifugal filter assembly of claim 26, wherein said channel includes a plurality of internal threads, said fluid flow restrictor having a plurality of external threads engaging said internal threads of said channel, said internal threads defining a first diameter, said external threads defining a second diameter, said first diameter and said second diameter defining a gap therebetween through which the fluid medium can flow.

28. The centrifugal filter assembly of claim 27, wherein said first diameter comprises a first minor diameter, said second diameter comprising a second minor diameter.

29. The centrifugal filter assembly of claim 14, wherein said drive mechanism includes a turbine.

30. A motor vehicle, comprising:
an engine containing a fluid medium; and
a centrifugal filter assembly for filtering contaminants from the fluid medium, said filter assembly comprising:
a housing;
a filter disposed within said housing and rotatable relative to said housing about an axis of rotation, said filter having an inlet and an outlet for the fluid medium;
a vacuum device in communication with said outlet, said vacuum device configured to create a vacuum within said housing for drawing at least one of the fluid medium and air through said outlet; and
a drive mechanism having a rotatable output shaft coupled with said filter for rotating said filter about said axis of rotation.

31. The motor vehicle of claim 30, wherein said drive mechanism has a current draw of less than 20 amperes.

32. The motor vehicle of claim 30, wherein said vacuum device is configured for creating a low pressure region around said filter.

33. The motor vehicle of claim 30, wherein said filter assembly is attached to said engine.

34. A centrifugal filter assembly for filtering particulates from engine oil, comprising:
a housing;
a filter disposed within said housing and rotatable relative to said housing about an axis of rotation, said filter having an inlet and an outlet for the oil, said filter including a filter media therein, said filter media for filtering the particulates from the engine oil;
a vacuum device in communication with said outlet, said vacuum device being configured for creating a vacuum within said housing; and
an electric motor having a rotatable output device coupled with said filter for rotating said filter about said axis of rotation.

35. The centrifugal filter assembly of claim 34, wherein said vacuum device comprises a venturi section.

36. A centrifugal filter assembly for filtering particulates from engine oil, comprising:
a filter rotatable about an axis of rotation, said filter having an inlet and an outlet for the oil, said filter including a filter media therein, said filter media for filtering the particulates from the engine oil; and
an electric motor having a rotatable output device coupled with said filter for rotating said filter about said axis of rotation.

37. A filtration unit of a centrifugal filter assembly for filtering particulates from a fluid, said filtration unit comprising:
a rotating filter rotatable about a first axis of rotation, said filter receiving a first flow of the fluid, said first flow having a first flow rate;
a turbine connected to said filter, said turbine including a plurality of turbine blades extending generally radially relative to a second axis of rotation, said second axis of rotation being one of parallel to and concentric with said first axis of rotation; and
a nozzle having an outlet and being aligned relative to said turbine, whereby a second flow of the fluid is jetted from said nozzle to thereby impinge upon said turbine and cause said filter to rotate about said first axis of rotation, said second flow having a second flow rate, said nozzle being configured such that said second flow rate is substantially greater than said first flow rate.

38. The filtration unit of claim 37, wherein said nozzle is configured such that said second flow rate is at least twice as great as said first flow rate.

39. The filtration unit of claim 38, wherein said nozzle is configured such that said second flow rate is at least nine times as great as said first flow rate.

40. A method of filtering particulates from a fluid, said method comprising the steps of:
providing a centrifugal filter assembly including a filtration unit, said filtration unit comprising:
a rotating filter rotatable about a first axis of rotation;
a turbine connected to said filter, said turbine including a plurality of turbine blades extending generally radially relative to a second axis of rotation, said second axis of rotation being one of parallel to and concentric with said first axis of rotation; and
a nozzle having an outlet and being aligned relative to said turbine;
providing a first flow of the fluid to said filter, said first flow having a first flow rate; and
jetting a second flow of the fluid from said nozzle to thereby impinge upon said turbine and cause said filter to rotate about said first axis of rotation, said second flow having a second flow rate substantially greater than said first flow rate.

41. The method of claim 40, wherein said second flow rate is at least twice as great as said first flow rate.

42. The method of claim 41, wherein said second flow rate is at least nine times as great as said first flow rate.
